(19) United States
(12) Patent Application Publication
(10) Pub. No.: US 2026/0329090 A1
(43) Pub. Date: Oct. 22, 2026

(54) Display Tint Layer Driving

(71) Applicant: Apple Inc., Cupertino, CA (US)

(72) Inventors: Zachary M Beiley, Oakland, CA (US); Sean E Doris, San Francisco, CA (US); Youngbae Son, San Jose, CA (US); Chun Ge, San Jose, CA (US); Johan L Piper, Cupertino, CA (US); Ganghun Kim, Milpitas, CA (US); Pei-Yu Hou, Campbell, CA (US); Xiaonan Wen, San Jose, CA (US); Alexander D Schlaupitz, Longmont, CO (US); Shungneng Lee, Sunnyvale, CA (US); Ashkan Olyaei, Saratoga, CA (US); Adam Adjiwibawa, Cupertino, CA (US)

(21) Appl. No.: 19/486,596

(22) PCT Filed: Jun. 20, 2024
(86) PCT No.: PCT/US2024/034709

§ 371 Date: Nov. 21, 2025

Related U.S. Application Data
(60) Provisional application No. 63/511,581, filed on Jun. 30, 2023.
(60) Provisional application No. 63/613,564, filed on Dec. 21, 2023.

(51) Int. Cl. G02B 27/01; G02F 1/157; G02F 1/163

(52) U.S. Cl. CPC G02B 27/0172; G02F 1/157; G02F 1/163; G02B 2027/0118

(57) ABSTRACT

An electronic device may include a display with a waveguide that directs image light to an eye box using an output coupler. The display may include an electrically adjustable tint layer overlapping the output coupler and driven by a driver. The driver may be coupled to the tint layer using wires or one or more flexible printed circuit tails. The driver may include different circuit architectures. The driver may overdrive or underdrive the tint layer to accelerate a transition time of the tint layer. The driver may be periodically floated relative to the electrodes to save power. The driver may drive the tint layer at multiple pairs of drive terminals around the periphery of the tint layer. A voltage sensor may measure voltage across the tint layer at sense terminals that are offset from the drive terminals.

This application claims priority to U.S. Provisional Patent Application No. 63/511,581, filed Jun. 30, 2023, and U.S. Provisional Patent Application No. 63/613,564, filed Dec. 21, 2023, each of which is hereby incorporated by reference herein in its entirety.

### BACKGROUND

This disclosure relates to optical systems such as optical systems in electronic devices having displays.

Electronic devices can include displays that provide images near the eyes of a user. Such electronic devices often include virtual or augmented reality headsets with displays having optical elements that allow users to view the displays.

If care is not taken, images presented by the displays can be washed out by bright ambient light. It can also be difficult to provide the displays with structures that meet desired levels of optical, electrical, and mechanical performance.

### SUMMARY

An electronic device may include a waveguide that directs image light to an eye box using an output coupler. The output coupler may transmit world light to the eye box. The electronic device may include a tint layer overlapping the waveguide. The tint layer may transmit the world light to the output coupler. The tint layer may be electrically adjustable. The tint layer may be driven by a driver at one or more pairs of drive terminals at a lateral periphery of the tint layer.

If desired, the driver may include a current driver and a voltage driver. The driver may switch between using the current driver or the voltage driver to drive the tint layer. If desired, the current driver may overdrive or underdrive the tint layer. If desired, the driver may include a current sensor, a Coulomb counter, and/or a voltage sensor coupled to the tint layer at sense terminals for monitoring the state of the tint layer. The sense terminals may be separate and laterally offset from the drive terminals to mitigate resistive effects of the tint layer between its periphery and other locations when monitoring the state of the tint layer. If desired, the driver may include a buck converter and a low-dropout (LDO) regulator coupled in series with the buck converter. The driver may switch between using the buck converter or the LDO regulator to drive the tint layer.

An aspect of the disclosure provides an electronic device. The electronic device can include a waveguide configured to propagate first light, an optical coupler on the waveguide and configured to couple the first light out of the waveguide, and a tint layer overlapping the optical coupler and configured to pass second light to the waveguide. The tint layer can include a first substrate, a first electrode layered onto the first substrate, a second substrate, a second electrode layered onto the second substrate, and an electrochromic material interposed between the first and second electrodes. The electronic device can include a driver configured to generate a voltage across the first and second electrodes and a flexible printed circuit having a first lateral surface, a second lateral surface opposite the first lateral surface, a first conductive trace on the first lateral surface that couples the driver to the first electrode, and a second conductive trace on the second lateral surface that couples the driver to the second electrode.

An aspect of the disclosure provides an electronic device. The electronic device can include a waveguide configured to propagate first light, an optical coupler on the waveguide and configured to couple the first light out of the waveguide, and a tint layer overlapping the optical coupler and configured to pass second light to the waveguide. The tint layer can include a first substrate, a first electrode layered onto the first substrate, a second substrate, a second electrode layered onto the second substrate, and an electrochromic material interposed between the first and second electrodes. The electronic device can include a driver configured to generate a voltage across the first and second electrodes, a first flexible printed circuit tail having a first conductive trace that couples the driver to the first electrode, and a second flexible printed circuit tail having a second conductive trace that couples the driver to the second electrode.

An aspect of the disclosure provides an electronic device. The electronic device can include a waveguide configured to propagate first light, an optical coupler on the waveguide and configured to couple the first light out of the waveguide, and a tint layer overlapping the optical coupler and configured to pass second light to the waveguide. The tint layer can include a first substrate, a first electrode layered onto the first substrate, a second substrate, a second electrode layered onto the second substrate, and an electrochromic material interposed between the first and second electrodes. The electronic device can include a driver configured to generate a voltage across the first and second electrodes, a first conductive wire that couples the driver to the first electrode and that is soldered to the first electrode, and a second conductive wire that couples the driver to the second electrode and that is soldered to the second electrode.

An aspect of the disclosure provides an electronic device. The electronic device can include a waveguide configured to propagate first light, an optical coupler on the waveguide and configured to couple the first light out of the waveguide, a tint layer overlapping the optical coupler and configured to pass second light to the waveguide, the tint layer having first and second electrodes and an electrochromic material between the first and second electrodes, and a driver configured to generate a voltage across the first and second electrodes. The driver can include a first circuit configured to drive the first electrode based on a reference voltage, and a second circuit configured to drive the second electrode based on the reference voltage.

An aspect of the disclosure provides an electronic device. The electronic device can include a waveguide configured to propagate first light, an optical coupler on the waveguide and configured to couple the first light out of the waveguide, a tint layer overlapping the optical coupler and configured to pass second light to the waveguide, the tint layer having first and second electrodes and an electrochromic material between the first and second electrodes, and a driver configured to generate a voltage across the first and second electrodes. The driver can include a tunable circuit configured to drive both the first electrode and the second electrode.

An aspect of the disclosure provides an electronic device. The electronic device can include a waveguide configured to propagate first light, an optical coupler on the waveguide and configured to couple the first light out of the waveguide, a tint layer overlapping the optical coupler and configured to pass second light to the waveguide, the tint layer having first and second electrodes and an electrochromic material between the first and second electrodes, and a driver configured to generate a voltage across the first and second electrodes. The driver can be configured to assert the voltage at a first magnitude at which the tint layer exhibits a first tint level, assert the voltage at a second magnitude at which the tint layer exhibits a second tint level greater than the first tint level, the second magnitude being greater than the first magnitude, and pulse the voltage to a third magnitude greater than the second magnitude during a transition of the tint layer from the first tint level to the second tint level.

An aspect of the disclosure provides an electronic device. The electronic device can include a waveguide configured to propagate first light, an optical coupler on the waveguide and configured to couple the first light out of the waveguide, a tint layer overlapping the optical coupler and configured to pass second light to the waveguide, the tint layer having first and second electrodes and an electrochromic material between the first and second electrodes, and a driver configured to generate a voltage across the first and second electrodes. The driver can be configured to assert the voltage at a first magnitude at which the tint layer exhibits a first opacity, assert the voltage at a second magnitude at which the tint layer exhibits a second opacity less than the first opacity, the second magnitude being less than the first magnitude, and pulse the voltage to a third magnitude less than the second magnitude during a transition of the tint layer from the first opacity to the second opacity.

An aspect of the disclosure provides an electronic device. The electronic device can include a waveguide configured to propagate first light, an optical coupler on the waveguide and configured to couple the first light out of the waveguide, a tint layer overlapping the optical coupler and configured to pass second light to the waveguide, the tint layer having first and second electrodes and an electrochromic material between the first and second electrodes, a driver configured to generate a voltage across the first and second electrodes and at which the tint layer exhibits a tint level, control lines that couple the driver to the first and second electrodes, and a switch disposed on the control lines, wherein the switch is configured to periodically float the first and second electrodes with respect to the driver while the tint layer exhibits the tint level.

An aspect of the disclosure provides an electronic device. The electronic device may include a waveguide configured to propagate first light. The electronic device may include an optical coupler on the waveguide and configured to couple the first light out of the waveguide. The electronic device may include a tint layer overlapping the optical coupler and configured to pass second light to the waveguide. The electronic device may include a driver configured to drive the tint layer at a first location on the tint layer. The electronic device may include a sensor coupled to a second location on the tint layer, the second location being different from the first location.

An aspect of the disclosure provides an electronic device. The electronic device may include a waveguide configured to propagate first light. The electronic device may include an optical coupler on the waveguide and configured to couple the first light out of the waveguide. The electronic device may include a tint layer overlapping the optical coupler and configured to pass second light to the waveguide, the tint layer having first and second electrodes and an electrochromic material between the first and second electrodes. The electronic device may include a driver configured to generate a voltage across the first and second electrodes. The driver may include a digital-to-analog converter (DAC). The driver may include a buck converter. The driver may include a low-dropout (LDO) regulator coupled in series with the buck converter between the DAC and the tint layer.

An aspect of the disclosure provides an electronic device. The electronic device may include a waveguide configured to propagate first light. The electronic device may include an optical coupler on the waveguide and configured to couple the first light out of the waveguide. The electronic device may include a tint layer overlapping the optical coupler and configured to pass second light to the waveguide, the tint layer having first and second electrodes and an electrochromic material between the first and second electrodes. The electronic device may include a current driver configured to drive, at a first time, the tint layer using a drive current. The electronic device may include a voltage driver configured to drive, at a second time different than the first time, the tint layer using a voltage across the first and second electrodes.

### BRIEF DESCRIPTION OF THE DRAWINGS

FIG. 1 is a diagram of an illustrative system having a display in accordance with some embodiments.

FIG. 2 is a top view of an illustrative optical system for a display having a waveguide with a tint layer for providing a virtual object overlaid with a real-world object to an eye box in accordance with some embodiments.

FIG. 3 is a front view of an illustrative tint layer having an electrochromic gel surrounded by a peripheral edge seal in accordance with some embodiments.

FIG. 4 is a diagram of an illustrative tint layer having electrodes that are driven by a driver in accordance with some embodiments.

FIG. 5 is a cross-sectional top view of an illustrative tint layer having electrodes that are driven by a single flexible printed circuit tail in accordance with some embodiments.

FIG. 6 is a cross-sectional top view of an illustrative tint layer having electrodes that are driven by different flexible printed circuit tails in accordance with some embodiments.

FIG. 7 is a cross-sectional top view of an illustrative tint layer having electrodes that are driven by conductive wires in accordance with some embodiments.

FIG. 8 is a circuit diagram of an illustrative driver having a buck converter that drives a first electrode of a tint layer and having a low-dropout (LDO) regulator and an inverter that drive a second electrode of the tint layer in accordance with some embodiments.

FIG. 9 is a circuit diagram of an illustrative driver having a first buck converter that drives a first electrode of a tint layer and having a second buck converter that drives a second electrode of the tint layer in accordance with some embodiments.

FIG. 10 is a circuit diagram of an illustrative driver having a single inductor multiple output (SIMO) buck converter that drives opposing electrodes of a tint layer in accordance with some embodiments.

FIG. 11 is a circuit diagram of an illustrative driver having an analog buffer that drives opposing electrodes of a tint layer in accordance with some embodiments.

FIG. 12 is a circuit diagram of an illustrative driver having first and second digital-to-analog converters (DACs) and buffers that drive opposing electrodes of a tint layer in accordance with some embodiments.

FIG. 13 is a circuit diagram of an illustrative driver having three DACs and buffers that drive two tint layers in accordance with some embodiments.

FIG. 14 is a circuit diagram of an illustrative driver having first and second tunable circuit blocks that drive opposing electrodes of a tint layer in accordance with some embodiments.

FIG. 15 is a circuit diagram of an illustrative driver having three tunable circuit blocks that drive two tint layers in accordance with some embodiments.

FIG. 16 is a circuit diagram of an illustrative driver having a tunable circuit block and an H-bridge that drive opposing electrodes of a tint layer in accordance with some embodiments.

FIG. 17 is a timing diagram showing how an illustrative tint layer may be driven using a binary voltage in accordance with some embodiments.

FIG. 18 is a timing diagram showing how an illustrative tint layer may be driven using an overdriven voltage in accordance with some embodiments.

FIG. 19 is a timing diagram showing how an illustrative tint layer may be driven using a gradual voltage pulse in accordance with some embodiments.

FIG. 20 is a timing diagram showing how an illustrative tint layer may be periodically disconnected from its driver in accordance with some embodiments.

FIG. 21 is a circuit diagram of an illustrative driver having a current drive circuit and a voltage drive circuit for driving a tint layer and having current and voltage sensors for measuring a state of the tint layer in accordance with some embodiments.

FIG. 22 is a flow chart of illustrative operations involved in switching between driving a tint layer using a current drive circuit and a voltage drive circuit in accordance with some embodiments.

FIG. 23 is a timing diagram showing how an illustrative tint layer may be driven using an overdriven current in accordance with some embodiments.

FIG. 24 is a front view of an illustrative tint layer that is driven by multiple pairs of drive terminals along its periphery and that has a dedicated sense terminal for sensing a voltage across the tint layer in accordance with some embodiments.

FIG. 25 is a front view of an illustrative tint layer that is continuously driven along its periphery in accordance with some embodiments.

FIG. 26 is a circuit diagram of an illustrative driver having a buck converter and an LDO regulator that each drives both electrodes of a tint layer in accordance with some embodiments.

FIG. 27 is a flow chart of illustrative operations involved in switching between driving a tint layer using a buck converter and an LDO regulator in accordance with some embodiments.

### DETAILED DESCRIPTION

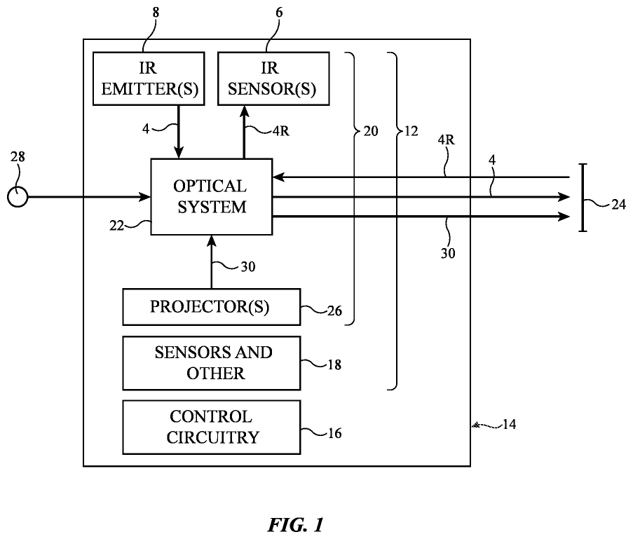

System 10 of FIG. 1 may be an electronic device such as a head-mounted device having one or more displays. System 10 may sometimes also be referred to herein as device 10. The displays in system 10 may include near-eye displays 20 mounted within support structure such as housing 14. Housing 14 may have the shape of a pair of eyeglasses or goggles (e.g., supporting frames), may form a housing having a helmet shape, or may have other configurations to help in mounting and securing the components of near-eye displays 20 on the head or near the eye of a user. Near-eye displays 20 may include one or more display projectors such as projectors 26 (sometimes referred to herein as display modules 26) and one or more optical systems such as optical systems 22. Projectors 26 may be mounted in a support structure such as housing 14. Each projector 26 may emit image light 30 that is redirected towards a user's eyes at eye box 24 using an associated one of optical systems 22. Image light 30 may be, for example, visible light (e.g., including wavelengths from 400-700 nm) that contains and/or represents something viewable such as a scene or object (e.g., as modulated onto the image light using the image data provided by the control circuitry to the display module).

The operation of system 10 may be controlled using control circuitry 16. Control circuitry 16 may include storage and processing circuitry for controlling the operation of system 10. Control circuitry 16 may include storage such as hard disk drive storage, nonvolatile memory (e.g., electrically-programmable-read-only memory configured to form a solid state drive), volatile memory (e.g., static or dynamic random-access-memory), etc.

Processing circuitry in control circuitry 16 may include one or more processors (e.g., microprocessors, microcontrollers, digital signal processors, baseband processors, etc.), power management units, audio chips, graphics processing units, application specific integrated circuits, and other integrated circuits. Software code may be stored on storage in control circuitry 16 and run on processing circuitry in control circuitry 16 to implement operations for system 10 (e.g., data gathering operations, operations involving the adjustment of components using control signals, image rendering operations to produce image content to be displayed for a user, etc.).

System 10 may include input-output circuitry such as input-output devices 12. Input-output devices 12 may be used to allow data to be received by system 10 from external equipment (e.g., a tethered computer, a portable device such as a handheld device or laptop computer, or other electrical equipment) and to allow a user to provide head-mounted system 10 with user input. Input-output devices 12 may also be used to gather information on the environment in which system 10 (e.g., head-mounted system 10) is operating. Output components in devices 12 may allow system 10 to provide a user with output and may be used to communicate with external electrical equipment. Input-output devices 12 may include sensors and other components 18 (e.g., image sensors for gathering images of real-world object that are digitally merged with virtual objects on a display in system 10, accelerometers, depth sensors, light sensors, haptic output devices, speakers, batteries, wireless communications circuits for communicating between system 10 and external electronic equipment, etc.).

Projectors 26 may include liquid crystal displays, organic light-emitting diode displays, laser-based displays, or displays of other types. Projectors 26 may include light sources, emissive display panels, transmissive display panels that are illuminated with illumination light from light sources to produce image light, reflective display panels such as digital micromirror display (DMD) panels and/or liquid crystal on silicon (LCOS) display panels that are illuminated with illumination light from light sources to produce image light 30, etc.

Optical systems 22 may form lenses that allow a viewer (see, e.g., a viewer's eyes at eye box 24) to view images on display(s) 20. There may be two optical systems 22 (e.g., for forming left and right lenses) associated with respective left and right eyes of the user. A single display 20 may produce images for both eyes or a pair of displays 20 may be used to display images. In configurations with multiple displays (e.g., left and right eye displays), the focal length and positions of the lenses formed by system 22 may be selected so that any gap present between the displays will not be visible to a user (e.g., so that the images of the left and right displays overlap or merge seamlessly).

If desired, optical system 22 may contain components (e.g., an optical combiner formed from reflective components, diffractive components, a waveguide, a direct view optical combiner, etc.) to allow real-world light (sometimes referred to as world light, scene light, environmental light, external light, or ambient light) from real-world (external) objects such as real-world (external) object 28 to be combined optically with virtual (computer-generated) images such as virtual images in image light 30. In this type of system, which is sometimes referred to as an augmented reality system, a user of system 10 may view both real-world content (e.g., world light from object 28) and computer-generated content that is overlaid on top of the real-world content. Camera-based augmented reality systems may also be used in system 10 (e.g., in an arrangement in which a camera captures real-world images of object 28 and this content is digitally merged with virtual content at optical system 22).

System 10 may, if desired, include wireless circuitry and/or other circuitry to support communications with a computer or other external equipment (e.g., a computer that supplies display 20 with image content). During operation, control circuitry 16 may supply image content to display 20. The content may be remotely received (e.g., from a computer or other content source coupled to system 10) and/or may be generated by control circuitry 16 (e.g., text, other computer-generated content, etc.). The content that is supplied to display 20 by control circuitry 16 may be viewed by a viewer at eye box 24.

If desired, system 10 may include an optical sensor. The optical sensor may be used to gather optical sensor data associated with a user's eyes at eye box 24. The optical sensor may, for example, be a gaze tracking sensor that gathers optical sensor data such as gaze image data (gaze tracking image data or gaze tracking sensor data) from a user's eye at eye box 24. Control circuitry 16 may process the optical sensor data to identify and track the direction of the user's gaze in real time. Control circuitry 16 may perform any desired operations based on the tracked direction of the user's gaze over time.

As shown in FIG. 1, the optical sensor (gaze tracking sensor) may include one or more optical emitters such as infrared emitter(s) 8 and one or more optical receivers (sensors) such as infrared sensor(s) 6 (sometimes referred to herein as optical sensor 6). Infrared emitter(s) 8 may include one or more light sources that emit sensing light such as light 4. Light 4 may be used for performing optical sensing on/at eye box 24 (e.g., gaze tracking) rather than conveying pixels of image data such as in image light 30. Light 4 may include infrared light. The infrared light may be at infrared (IR) wavelengths and/or near-infrared (NIR) wavelengths (e.g., any desired wavelengths from around 700 nm to around 15 microns). Light 4 may additionally or alternatively include wavelengths less than 700 nm if desired. Light 4 may sometimes be referred to herein as sensor light 4.

Infrared emitter(s) 8 may direct light 4 towards optical system 22. Optical system 22 may direct the light 4 emitted by infrared emitter(s) 8 towards eye box 24. Light 4 may reflect off portions (regions) of the user's eye at eye box 24 as reflected light 4R (sometimes referred to herein as reflected sensor light 4R, which is a reflected version of light 4). Optical system 22 may receive reflected light 4R and may direct reflected light 4R towards infrared sensor(s) 6. Infrared sensor(s) 6 may receive reflected light 4R from optical system 22 and may gather (e.g., generate, measure, sense, produce, etc.) optical sensor data in response to the received reflected light 4R. Infrared sensor(s) 6 may include an image sensor or camera (e.g., an infrared image sensor or camera), for example. Infrared sensor(s) 6 may include, for example, one or more image sensor pixels (e.g., arrays of image sensor pixels). The optical sensor data may include image sensor data (e.g., image data, infrared image data, one or more images, etc.). Infrared sensor(s) 6 may pass the optical sensor data to control circuitry 16 for further processing. Infrared sensor(s) 6 and infrared emitter(s) 8 may be omitted if desired.

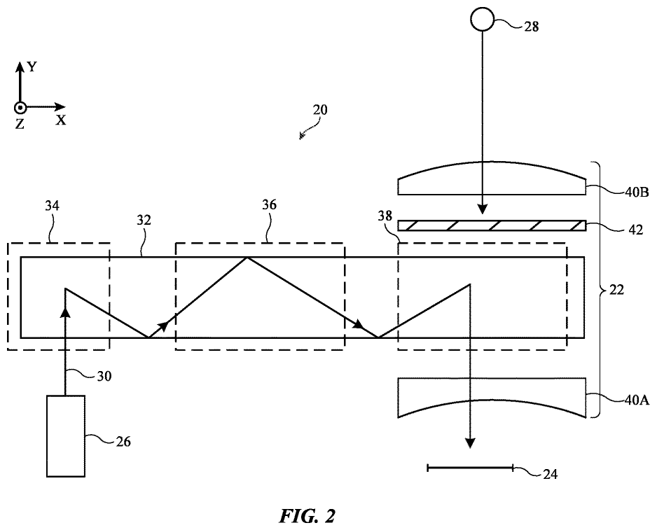

FIG. 2 is a top view of an illustrative display 20 that may be used in system 10 of FIG. 1. As shown in FIG. 2, display 20 may include a projector such as projector 26 and an optical system such as optical system 22. Optical system 22 may include optical elements such as one or more waveguides 32. Waveguide 32 may include one or more stacked substrates (e.g., stacked planar and/or curved layers sometimes referred to herein as waveguide substrates) of optically transparent material such as plastic, polymer, glass, etc.

If desired, waveguide 32 may also include one or more layers of holographic recording media (sometimes referred to herein as holographic media, grating media, or diffraction grating media) on which one or more diffractive gratings are recorded (e.g., holographic phase gratings, sometimes referred to herein as holograms, surface relief gratings, etc.). A holographic recording may be stored as an optical interference pattern (e.g., alternating regions of different indices of refraction) within a photosensitive optical material such as the holographic media. The optical interference pattern may create a holographic phase grating that, when illuminated with a given light source, diffracts light to create a three-dimensional reconstruction of the holographic recording. The holographic phase grating may be a non-switchable diffractive grating that is encoded with a permanent interference pattern or may be a switchable diffractive grating in which the diffracted light can be modulated by controlling an electric field applied to the holographic recording medium. Multiple holographic phase gratings (holograms) may be recorded within (e.g., superimposed within) the same volume of holographic medium if desired. The holographic phase gratings may be, for example, volume holograms or thin-film holograms in the grating medium. The grating medium may include photopolymers, gelatin such as dichromated gelatin, silver halides, holographic polymer dispersed liquid crystal, or other suitable holographic media.

Diffractive gratings on waveguide 32 may include holographic phase gratings such as volume holograms or thin-film holograms, meta-gratings, or any other desired diffractive grating structures. The diffractive gratings on waveguide 32 may also include surface relief gratings (SRGs) formed on one or more surfaces of the substrates in waveguide 32 (e.g., as modulations in thickness of a SRG medium layer) or gratings formed from metamaterials or metasurfaces. The diffractive gratings may, for example, include multiple multiplexed gratings (e.g., holograms) that at least partially overlap within the same volume of grating medium (e.g., for diffracting different colors of light and/or light from a range of different input angles at one or more corresponding output angles). Other light redirecting elements such as louvered mirrors may be used in place of diffractive gratings in waveguide 32 if desired.

As shown in FIG. 2, projector 26 may generate (e.g., produce and emit) image light 30 associated with image content to be displayed to eye box 24 (e.g., image light 30 may convey a series of image frames for display at eye box 24). Image light 30 may be collimated using a collimating lens in projector 26 if desired. Optical system 22 may be used to present image light 30 output from projector 26 to eye box 24. If desired, projector 26 may be mounted within support structure 14 of FIG. 1 while optical system 22 may be mounted between portions of support structure 14 (e.g., to form a lens that aligns with eye box 24). Other mounting arrangements may be used, if desired.

Optical system 22 may include one or more optical couplers (e.g., light redirecting elements) such as input coupler 34, cross-coupler 36, and output coupler 38. In the example of FIG. 2, input coupler 34, cross-coupler 36, and output coupler 38 are formed at or on waveguide 32. Input coupler 34, cross-coupler 36, and/or output coupler 38 may be completely embedded within the substrate layers of waveguide 32, may be partially embedded within the substrate layers of waveguide 32, may be mounted to waveguide 32 (e.g., mounted to an exterior surface of waveguide 32), etc.

Waveguide 32 may guide image light 30 down its length via total internal reflection. Input coupler 34 may be configured to couple image light 30 from projector 26 into waveguide 32 (e.g., within a total-internal reflection (TIR) range of the waveguide within which light propagates down the waveguide via TIR), whereas output coupler 38 may be configured to couple image light 30 from within waveguide 32 (e.g., propagating within the TIR range) to the exterior of waveguide 32 and towards eye box 24 (e.g., at angles outside of the TIR range). Input coupler 34 may include an input coupling prism, an edge or face of waveguide 32, a lens, a steering mirror or liquid crystal steering element, diffractive grating structures (e.g., volume holograms, SRGs, etc.), partially reflective structures (e.g., louvered mirrors), or any other desired input coupling elements.

As an example, projector 26 may emit image light 30 in direction +Y towards optical system 22. When image light 30 strikes input coupler 34, input coupler 34 may redirect image light 30 so that the light propagates within waveguide 32 via total internal reflection towards output coupler 38 (e.g., in direction +X within the TIR range of waveguide 32). When image light 30 strikes output coupler 38, output coupler 38 may redirect image light 30 out of waveguide 32 towards eye box 24 (e.g., back along the Y-axis). In implementations where cross-coupler 36 is formed on waveguide 32, cross-coupler 36 may redirect image light 30 in one or more directions as it propagates down the length of waveguide 32 (e.g., towards output coupler 38 from a direction of propagation as coupled into the waveguide by the input coupler). In redirecting image light 30, cross-coupler 36 may also perform pupil expansion on image light 30 in one or more directions. In expanding pupils of the image light, cross-coupler 36 may, for example, help to reduce the vertical size of waveguide 32 (e.g., in the Z direction) relative to implementations where cross-coupler 36 is omitted. Cross-coupler 36 may therefore sometimes also be referred to herein as pupil expander 36 or optical expander 36. If desired, output coupler 38 may also expand image light 30 upon coupling the image light out of waveguide 32.

Input coupler 34, cross-coupler 36, and/or output coupler 38 may be based on reflective and refractive optics or may be based on diffractive (e.g., holographic) optics. In arrangements where couplers 34, 36, and 38 are formed from reflective and refractive optics, couplers 34, 36, and 38 may include one or more reflectors (e.g., an array of micromirrors, partial mirrors, louvered mirrors, or other reflectors). In arrangements where couplers 34, 36, and 38 are based on diffractive optics, couplers 34, 36, and 38 may include diffractive gratings (e.g., volume holograms, surface relief gratings, etc.).

The example of FIG. 2 is merely illustrative. Optical system 22 may include multiple waveguides that are laterally and/or vertically stacked with respect to each other. Each waveguide may include one, two, all, or none of couplers 34, 36, and 38. Waveguide 32 may be at least partially curved or bent if desired. One or more of couplers 34, 36, and 38 may be omitted. If desired, optical system 22 may include a single optical coupler that performs the operations of both cross-coupler 36 and output coupler 38 (sometimes referred to herein as an interleaved coupler, a diamond coupler, or a diamond expander) or cross-coupler 36 may be separate from output coupler 38.

The operation of optical system 22 on image light 30 is shown in FIG. 2. Optical system 22 may also direct light 4 from infrared emitter(s) 8 towards eye box 24 and may direct reflected light 4R from eye box 24 towards infrared sensor(s) 6 (FIG. 1). In addition, output coupler 38 may form an optical combiner for image light 30 and world light from real-world objects such as real-world object 28. As shown in FIG. 2, world light from real-world object 28 may pass through output coupler 38, which transmits the world light (e.g., without diffracting the world light) to eye box 24.

Image light 30 may include images of virtual objects, sometimes referred to herein as virtual object images or simply as virtual objects. Projector 26 may receive image data that includes the virtual object images (e.g., pixels of image data at different pixel locations that form the virtual object images). Output coupler 38 may serve to overlay the virtual object images with world light from real-world object 28 within the field of view (FOV) of eye box 24. The control circuitry for system 10 may provide image data to projector 26 that places the virtual object images at desired locations within the FOV at eye box 24 (e.g., such that the virtual object images are overlaid with desired real-world objects in the scene/environment in front of system 10.)

Optical system 22 may include one or more lenses 40 that overlap output coupler 38. For example, optical system 22 may include at least a first lens 40A and a second lens 40B. Lens 40B may be interposed between waveguide 32 and real-world object 28. Lens 40A may be interposed between waveguide 32 and eye box 24. Lenses 40 are transparent and allow world light from real-world object 28 to pass to eye box 24 for viewing by the user. At the same time, the user can view virtual object images directed out of waveguide 32 and through lens 40A to eye box 24. Lenses 40A and 40B may sometimes also be referred to herein as lens elements.

The strength (sometimes referred to as the optical power, power, or diopter) of lens 40A can be selected to place virtual object images in image light 30 at a desired image distance (depth) from eye box 24 (sometimes referred to herein as a virtual object distance, virtual object image distance, virtual image distance (VID), virtual object depth, virtual image depth, or image depth). For example, it may be desirable to place virtual objects (virtual object images) such as text, icons, moving images, characters, effects, or other content or features at a certain virtual image distance (e.g., to integrate the virtual object image within, onto, into, or around the real-world objects in front of system 10). The placement of the virtual object at that distance can be accomplished by appropriate selection of the strength of lens 40A. Lens 40A may be a negative lens for users whose eyes do not have refraction errors. The strength (larger net negative power) of lens 40A can therefore be selected to adjust the distance (depth) of the virtual object. Lens 40A may therefore sometimes be referred to herein as bias lens 40A or bias− (B−) lens 40A.

If desired, lens 40B may have a complementary power value (e.g., a positive power with a magnitude that matches the magnitude of the negative power of lens 40A). Lens 40B may therefore sometimes be referred to herein as bias+ (B+) lens 40B, complementary lens 40B, or compensation lens 40B. For example, if lens 40A has a power of −2.0 diopter, lens 40B may have an equal and opposite power of +2.0 diopter (as an example). In this type of arrangement, the positive power of lens 40B cancels the negative power of lens 40A. As a result, the overall power of lenses 40A and 40B taken together will be 0 diopter. This allows a viewer to view real-world objects such as real-world object 28 without optical influence from lenses 40A and 40B. For example, a real-world object 28 located far away from system 10 (effectively at infinity) may be viewed as if lenses 40A and 40B were not present.

For a user with satisfactory uncorrected vision, this type of complementary lens arrangement therefore allows virtual objects to be placed in close proximity to the user (e.g., at a virtual image distance of 0.5-5 m, at least 0.1 m, at least 1 m, at least 2 m, less than 20 m, less than 10 m, less than 5 m, or other suitable near-to-midrange distance from device 10 while simultaneously allowing the user to view real world objects without modification by the optical components of the optical system). For example, a real-world object located at a distance of 2 m from device 10 (e.g., a real-world object being labeled by a virtual text label at a virtual image distance of 2 m) will optically appear to be located 2 m from device 10. This is merely illustrative and, if desired, lenses 40A and 40B need not be complementary lenses (e.g., lenses 40A and 40B may have any desired optical powers).

In addition, some users may require vision correction. Vision correction may be provided using tunable lenses, fixed (e.g., removable) lenses (sometimes referred to as supplemental lenses, vision correction lenses, removable lenses, or clip-on lenses), and/or by adjusting the optical power of lens 40A and/or lens 40B to implement the desired vision correction. In general, the vision correction imparted to the lens(es) may include corrections for ametropia (eyes with refractive errors) such as lenses to correct for nearsightedness (myopia), corrections for farsightedness (hyperopia), corrections for astigmatism, corrections for skewed vision, corrections to help accommodate age-related reductions in the range of accommodation exhibited by the eyes (sometimes referred to as presbyopia), and/or other vision disorders.

Lenses 40A and 40B may be provided with any desired optical powers and any desired shapes (e.g., may be plano-convex lenses, plano-concave lenses, plano-freeform lenses, freeform-convex lenses, freeform-concave lenses, convex-concave lenses, freeform-freeform lenses, etc.). Implementations in which the optical power(s) of lenses 40A and/or 40B are fixed (e.g., upon manufacture) are described herein as an example. If desired, one or both of lenses 40A and/or 40B may be electrically adjustable to impart different optical powers or power profiles over time (e.g., lenses 40A and/or 40B may be adjustable/tunable liquid crystal lenses).

In some operating conditions, such as when system 10 is operated outdoors, in rooms with bright lighting, or in other environments having relatively high light levels, world light from real-world objects 28 can overpower or wash out virtual objects presented to eye box 24 in image light 30, thereby limiting the contrast and visibility of the virtual objects when viewed at eye box 24. To reduce the brightness of the world light and maximize the contrast of the images (virtual objects) in image light 30 when viewed at eye box 24, optical system 22 may include a light-absorbing layer such as tint layer 42. Tint layer 42 may be disposed within the optical path between real-world objects 28 and output coupler 38. The world light from real-world objects 28 may pass through tint layer 42 prior to reaching eye box 24 (e.g., tint layer 42 may transmit the world light without transmitting image light 30). Tint layer 42 may absorb some of the real-world light, thereby reducing its brightness and increasing the contrast of virtual objects in image light 30 at eye box 24. If desired, the tint layer may also function to absorb real-world light even when the virtual image is turned off, performing a function like switchable sunglasses.

Tint layer 42 may be a fixed tint layer or may be a dynamically adjustable tint layer. When implemented as a fixed tint layer, tint layer 42 has a fixed transmission profile that absorbs the same amount of incident world light over time. Fixed tint layers may be formed from a polymer film containing dye and/or pigment (as an example). When implemented as a dynamically (electrically) adjustable tint layer, tint layer 42 has a dynamically (electrically) adjustable transmission profile. In these implementations, tint layer 42 may be controlled by control signals from control circuitry 16. Implementations in which tint layer 42 is a dynamically adjustable tint layer are described herein as an example. However, in general, tint layer 42 as described herein may be replaced with a fixed tint layer.

Electrically adjustable tint layers (sometimes referred to as electrically adjustable light modulators or electrically adjustable light modulator layers) may be formed from an organic or inorganic electrochromic light modulator layer or a guest-host liquid crystal light modulator layer. When implemented using organic electrochromic tint materials, the active tint materials in the tint layer may be formed from one or more polymer layers which change their absorption upon being oxidized or reduced by charge from adjacent electrodes, or the active tint materials in the tint layer may be made from one or more species of organic small molecules, which diffuse in a liquid or gel medium and change their absorption upon being oxidized or reduced by charge from adjacent electrodes. When implemented using inorganic electrochromic tint materials, the active tint materials may be formed from one or more metal oxides, which change their absorption upon being oxidized or reduced by charge from adjacent electrodes, and may include counter-ions. Implementations in which tint layer 42 includes electrochromic tint material such as a layer of cured electrochromic gel are described herein as an example.

During operation of system 10, the electrically adjustable tint layer may be dynamically placed in a high transmission mode (sometimes referred to herein as a clear state) when it is desired to enhance the visibility of real-world objects or in a lower transmission mode (sometimes referred to herein as a dark state) when it is desired to reduce scene brightness and thereby help enhance the viewability of image light from projector 26 (e.g., to allow virtual objects such as virtual objects in image light 30 to be viewed without being overwhelmed by bright environmental light). If desired, tint layer 42 may also be controlled to exhibit intermediate levels of transmission and/or transmission levels that vary across the field of view of eye box 24.

Tint layer 42 may be planar (e.g., having a lateral surface that lies in a flat plane) or may be curved (e.g., having a lateral surface that is curved and non-planar). Tint layer 42 may be disposed at any desired location within optical system 22 between real-world objects 28 (e.g., the scene in front of system 10) and output coupler 38 on waveguide 32. System 10 may include multiple overlapping tint layers if desired.

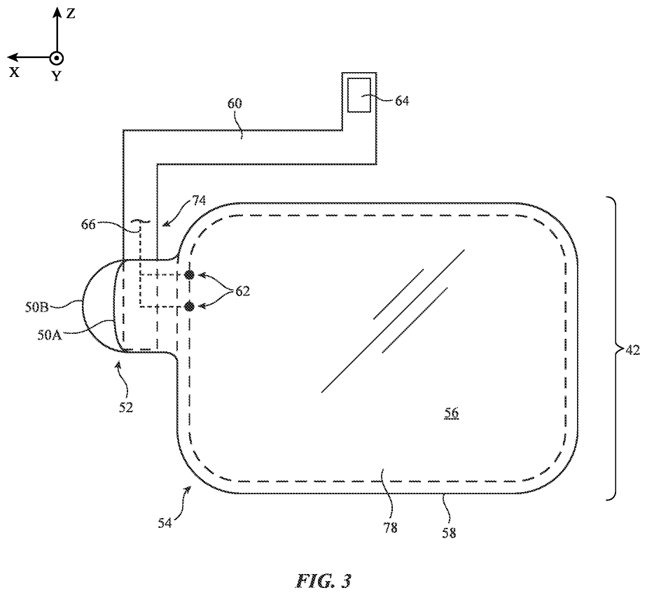

FIG. 3 is a front view of tint layer 42. In the example of FIG. 3, waveguide 32, projector 26, and lenses 40 of FIG. 2 have been omitted for the sake of clarity. As shown in FIG. 3, tint layer 42 may include one or more substrates layers 50 such as a first substrate 50A and a second substrate 50B. Substrates 50A and 50B may include glass (e.g., substrates 50A and 50B may be glass layers), polymer (e.g., plastic), or other transparent materials. Substrate layers 50 may sometimes also be referred to herein simply as substrates 50. Substrates 50A and 50B may sometimes also be referred to herein as substrate layers 50A and 50B or simply as layers 50A and 50B.

Substrate 50B may overlap substrate 50A and may be mounted to substrate 50A. When mounted together, substrates 50A and 50B may define a cavity between substrate 50A and substrate 50B. The cavity may be filled with a layer of electrochromic tint material such as electrochromic gel 78. Electrochromic gel 78 may form the active area 56 of tint layer 42. Tint layer 42 may transmit light to waveguide 32 through active area 56 of tint layer 42 (e.g., while absorbing some of the light, providing the transmitted light with a desired color response, etc.).

Electrochromic gel 78 may be cured and/or solidified during manufacture of tint layer 42. Electrochromic gel 78 may sometimes also be referred to herein as electrochromic layer 78, electrochromic tint material 78, electrochromic material 78, or tint material 78. A peripheral ring of adhesive such as peripheral edge seal 58 may be used to laterally contain electrochromic gel 78 within active area 56 while helping to space substrate 50A apart from substrate 50B. Peripheral edge seal 58 may also serve to mount or adhere substrates 50A and 50B together.

As shown in FIG. 3, substrates 50A and 50B may include an extension 52 that extends or protrudes away from electrochromic gel 78 and peripheral edge seal 58. Tint layer 42 may be driven by one or more control lines coupled to tint layer 42 at or through extension 52. For example, tint layer 42 may be driven by a printed circuit board such as flexible printed circuit 60. Flexible printed circuit 60 may include one or more control lines 66 (e.g., one or more conductive traces or other conductive lines). Control lines 66 may be coupled to control circuitry 16 (FIG. 1) over connector 64 (e.g., a board-to-board connector). Control lines 66 may extend into one or more tails 74 of flexible printed circuit 60. Tail(s) 74 of flexible printed circuit 60 may be coupled to tint layer 42 (e.g., at extension 52). Tail(s) 74 of flexible printed circuit 60 may, if desired, be adhered or mounted to substrate 50A and/or substrate 50B. Tail(s) 74 may sometimes also be referred to herein as flexible printed circuit tails.

Tint layer 42 may include first and second transparent conductive layers (not shown in FIG. 3 for the sake of clarity) extending along the lateral area of substrates 50A and 50B and the electrochromic gel 78 in active area 56. The transparent conductive layers may form electrodes for tint layer 42. The electrodes may be formed from any desired transparent conductive material (e.g., indium tin oxide (ITO)). The electrodes may extend along opposing sides of electrochromic gel 78. The electrodes may have terminals 62 that are coupled to control lines 66 on flexible printed circuit 60. Control lines 66 are sometimes also be referred to herein as drive lines 66. Terminals 66 are sometimes also referred to herein as drive terminals 66.

Flexible printed circuit 60 may receive control signals such as different control voltages and/or currents from control circuitry 16 (FIG. 1) for driving, controlling, setting, and/or adjusting the light transmission properties of tint layer 42. Flexible printed circuit 60 may pass the control signals to the electrodes of tint layer 42 over control lines 66 and drive terminals 62. By adjusting the voltage and/or current across terminals 62, the electric field applied by the electrodes of tint layer 42 across electrochromic gel 78 may be adjusted, thereby adjusting the amount of light transmission exhibited by electrochromic gel 78 and thus tint layer 42.

In an illustrative configuration, electrochromic gel 78 and tint layer 42 may exhibit a variable amount of light transmission ranging continuously between a minimum level of TMIN and a maximum level of TMAX. The value of TMIN may be 5%, 10%, 15%, 20%, 2-15%, 3-25%, 5-40%, 10-30%, 10-25%, at least 3%, at least 6%, at least 15%, at least 20%, less than 35%, less than 25%, less than 15%, or other suitable minimum level sufficient to help reduce environmental (real-world) light during viewing of computer-generated images from projectors 26 in bright environmental lighting conditions. The value of TMAX may be at least 50%, at least 60%, 60-99%, 40-99.9%, 80-99%, 70-99%, 80-97%, at least 70%, at least 80%, at least 85%, at least 90%, at least 95%, less than 99.99%, less than 99%, or other suitable maximum level sufficiently transparent to allow a viewer to comfortably view real world objects through tint layer 42 during situations where projectors 26 (FIG. 2) are not supplying images or other situations where higher transmission levels are desirable. If desired, the control signals may also be adjusted to adjust a color response (e.g., transmission as a function of wavelength) of electrochromic gel 78.

If desired, anti-reflective coatings (not shown), index matching layers (not shown), additional adhesive layers (not shown), and/or any other additional layers may be disposed on one or both of substrates 50A and 50B. In implementations where tint layer 42 is curved, substrates 50A and 50B may be curved. The example of FIG. 3 in which tint layer 42 includes two substrates 50 is illustrative and non-limiting. If desired, tint layer 42 may include only a single substrate 50 or more than two substrates 50.

In general, it may be desirable for tint layer 42 to be as flat as possible (e.g., within the X-Z plane of FIG. 3). Maximizing flatness may allow tint layer 42 to be more easily mounted within system 10 (e.g., to a surface waveguide 32 of FIG. 2), may allow tint layer 42 to be more mechanically robust over the operating lifetime of system 10 (e.g., with minimal damage to tint layer 42 and/or to the coupling between tint layer 42 and waveguide 32 over time as system 10 is subjected to external forces, thermal stress, etc.), may minimize the production of reflections, ghost, rainbow artifacts, or other cosmetic artifacts by tint layer 42, etc.

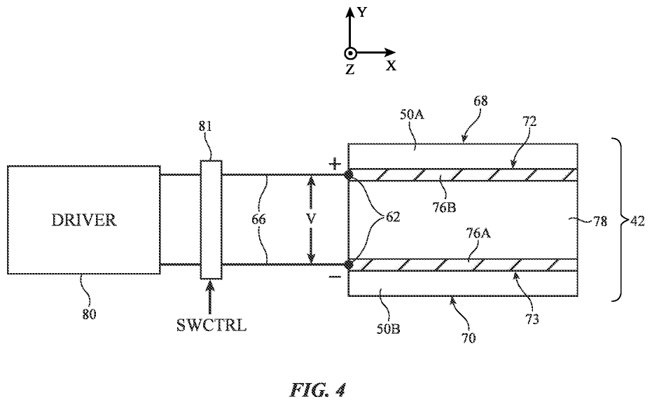

FIG. 4 is a diagram showing how tint layer 42 may be driven by a drive voltage provided over control lines 66. As shown in FIG. 4, tint layer 42 may be driven by driver circuitry such as driver 80. Driver 80 may be coupled to tint layer 42 over control lines 66. Driver 80 may be mounted to a substrate 50 of tint layer 42, may be mounted to flexible printed circuit 60 (FIG. 2), may be mounted to the main logic board or another logic board in system 10 (e.g., may be coupled to flexible printed circuit 60 over connector 64), may be implemented on an application specific integrated circuit (ASIC) that is specifically designed to drive tint layer 42, may be implemented on another control chip in system 10 that performs additional functions, etc.

FIG. 4 also shows a cross-sectional top view of tint layer 42. As shown in the cross-sectional top view of FIG. 4, substrates 50A and 50B may extend along opposing sides of electrochromic gel 78 (e.g., electrochromic gel 78 may be sandwiched or interposed between substrates 50A and 50B). Substrate 50A may have a first lateral surface 68 and an opposing second lateral surface 72. Substrate 50B may have a first lateral surface 73 and an opposing second lateral surface 70. Lateral surface 70 or lateral surface 68 may be mounted to a lateral surface of waveguide 32 (FIG. 2) using optically clear adhesive, epoxy, spacers, or other mounting structures. Lateral surfaces 72 and 73 may face electrochromic gel 78.

Tint layer 42 may include a first electrode layer such as electrode 76B that is layered onto lateral surface 72 and that is interposed between substrate 50A and electrochromic gel 78. Tint layer 42 may also include a second electrode layer such as electrode 76A that is layered onto lateral surface 73 and that is interposed between substrate 50B and electrochromic gel 78. Control lines 66 may be coupled to electrodes 76A and 76B at drive terminals 62 (e.g., driver 80 may be coupled to electrodes 76A and 76B over control lines 66 and drive terminals 62).

As shown in the example of FIG. 4, driver 80 may drive electrodes 76A and 76B using a control or drive voltage V applied across electrodes 76A and 76B through control lines 66. The magnitude and/or timing of voltage V may configure electrochromic gel 78 to exhibit a desired level of optical transmission and/or a desired color response. Voltage V may be adjusted over time to adjust the level of optical transmission and/or the color response of electrochromic gel 78 and thus tint layer 42.

If desired, a switch such as switch 81 may be disposed on control lines 66 between driver 80 and tint layer 42. Switch 81 may have a first state in which switch 81 is closed (active, enabled, turned on, etc.) and a second state in which switch 81 is open (e.g., inactive, disabled, turned off, etc.). In the first state, switch 81 may form a short circuit on control lines 66 and driver 80 may apply voltage V to electrodes 76 through switch 81. In the second state, switch 81 may form an open circuit on control lines 66. This may configure electrodes 76A and 76B to be electrically floating with respect to driver 80 (e.g., may decouple or disconnect driver 80 from tint layer 42) and may prevent the application of voltage V across electrodes 76A and 76B by driver 80.

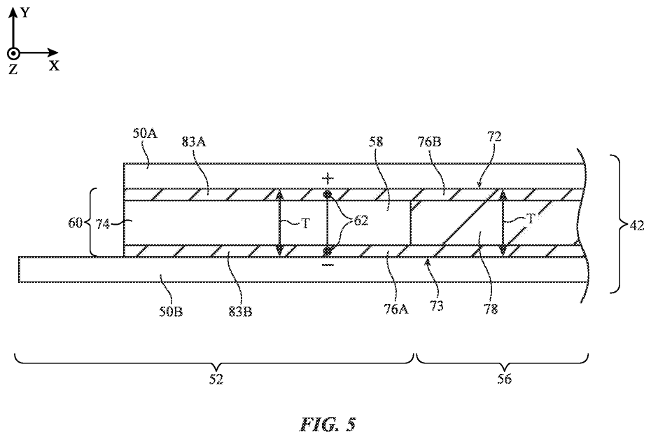

Control lines 66 may be disposed on one or more tails 74 of one or more flexible printed circuits 60 mounted to substrate 50A and/or substrate 50B of tint layer 42. FIG. 5 is a cross-sectional top view showing one example in which a single tail 74 of a single flexible printed circuit 60 is mounted to both substrates 50A and 50B and is used to drive both electrodes 76A and 76B.

As shown in FIG. 5, peripheral edge seal 58 may couple lateral surface 72 of substrate 50A to lateral surface 73 of substrate 50B. Peripheral edge seal 58 may extend around the lateral periphery of electrochromic gel 78 (e.g., as shown in FIG. 3) to confine (e.g., completely surround) electrochromic gel 78 within active area 56 and between substrates 50A and 50B. Peripheral edge seal 58 may help to prevent electrochromic gel 78 from leaking out of tint layer 42, may serve to protect electrochromic gel 78 from moisture or other contaminants, and may serve to prevent exposure of oxygen in the air around tint layer 42 to electrochromic gel 78, thereby allowing electrochromic gel 78 to continue to perform the expected redox reactions in response to voltages applied across the electrodes and without degrading or otherwise damaging the electrochromic gel, the redox reaction within the electrochromic gel, or the electrodes.

The material in peripheral edge seal 58 may exhibit relatively low cure shrinkage (e.g., to minimize stress on substrates 50A and 50B and to thereby allow tint layer 42 to remain as flat as possible after curing), may form a robust barrier to oxygen and/or water (e.g., to prevent contamination or damage to electrochromic gel 78), and/or may be chemically compatible with electrochromic gel 78 (e.g., does not chemically react with electrochromic gel 78). Peripheral edge seal 58 may be formed from epoxy or polyisobutylene, as two examples. If desired, tint layer 42 may include multiple concentric peripheral edge seals 58 around electrochromic gel 78. If desired, peripheral edge seal 58 may include a glass spacer ring that laterally extends around electrochromic gel 78 and that is adhered to substrates 50A and 50B. Peripheral edge seal 58 may laterally abut tail 74 or may be separated from tail 74 by an air gap (not shown) or a filler material (not shown) such as epoxy, molded plastic, etc.

As shown in FIG. 5, tail 74 of flexible printed circuit 60 may be disposed between substrates 50A and 50B of tint layer 42 (e.g., within protrusion 52). Conductive traces 83 in tail 74 may be used to form control lines 66. For example, a first control line 66 may include conductive traces 83A on a first lateral surface of tail 74 and a second control line 66 may include conductive traces 83B on a second lateral surface of tail 74 opposite the first lateral surface. Conductive traces 83A may be coupled to electrode 76B and conductive traces 83B may be coupled to electrode 76A at drive terminals 62.

While shown as being laterally adjacent to electrode 76B in FIG. 5 for the sake of simplicity, in practice conductive traces 83A on tail 74 may be layered onto electrode 76B (e.g., electrode 76B may extend along substrate 50A over tail 74 and a portion of electrode 76B may be vertically interposed between substrate 50A and conductive traces 83A). Similarly, while shown as being laterally adjacent to electrode 76A in FIG. 5 for the sake of simplicity, in practice conductive traces 83B on tail 74 may be layered onto electrode 76A (e.g., electrode 76A may extend along substrate 50B under tail 74 and a portion of electrode 76A may be vertically interposed between substrate 50B and conductive traces 83B).

Any desired materials may be used to form a mechanical and electrical connection between conductive traces 83A and electrode 76B and between conductive traces 83B and electrode 76A. As examples, conductive epoxy, anisotropic conductive film (ACF), conductive adhesive, pressure sensitive adhesive, silver paste, or any other desired materials may be used to couple, secure, affix, attach, mount, and/or adhere conductive traces 83A to electrode 76B and to couple, secure, affix, attach, mount, and/or adhere conductive traces 83B to electrode 76A. In this way, tail 74 of flexible printed circuit 60 may be mechanically attached to tint layer 42 while also providing an electrical connection between control lines 66 (conductive traces 83A and 83B) and electrodes 76.

Electrochromic gel 78 and electrodes 76 may have an overall thickness T. In other words, substrate 50A and substrate 50B may be separated from each other within active area 56 by thickness T. Tail 74 of flexible printed circuit 60 may also have thickness T to match the thickness of active area 56. This may, for example, prevent splaying of substrates 50A and 50B during manufacture of tint layer 42.

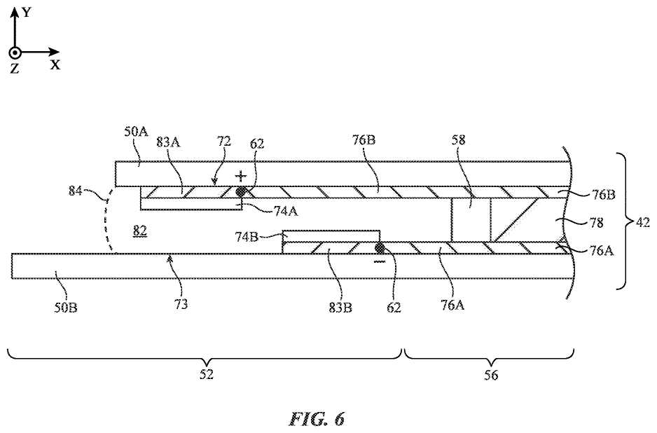

FIG. 6 is a cross-sectional top view showing one example in which multiple tails 74 of one or more flexible printed circuits 60 are mounted to substrates 50A and 50B and used to drive electrodes 76A and 76B. As shown in FIG. 6, a first tail 74A having conductive traces 83A may be mounted to substrate 50A. A second tail 74B having conductive traces 83B may be mounted to substrate 50B. Tails 74A and 74B may be tails of the same flexible printed circuit 60 (e.g., conductive traces 83A and 83B may be coupled to driver 80 over the same connector 64 (FIG. 3)) or may be tails of different respective flexible printed circuits 60 (e.g., conductive traces 83A and 83B may be coupled to driver 80 over different connectors 64). In configurations where tails 74A and 74B are tails of different flexible printed circuits, the different flexible printed circuits may be mounted or coupled together downstream if desired (e.g., conductive traces 83A and 83B may share the same connector 64 at a location after where the flexible printed circuits are coupled together, the same connector 64 may couple the different flexible circuits together and to a main logic board of system 10, etc.).

While shown as being laterally adjacent to electrode 76B in FIG. 6 for the sake of simplicity, in practice conductive traces 83A on tail 74A may be layered onto electrode 76B (e.g., electrode 76B may extend along substrate 50A over tail 74 and a portion of electrode 76B may be vertically interposed between substrate 50A and conductive traces 83A). Similarly, while shown as being laterally adjacent to electrode 76A in FIG. 5 for the sake of simplicity, in practice conductive traces 83B on tail 74 may be layered onto electrode 76A (e.g., electrode 76A may extend along substrate 50B under tail 74 and a portion of electrode 76A may be vertically interposed between substrate 50B and conductive traces 83B).

Any desired materials may be used to form a mechanical and electrical connection between conductive traces 83A and electrode 76B and between conductive traces 83B and electrode 76A. As examples, conductive epoxy, anisotropic conductive film (ACF), conductive adhesive, pressure sensitive adhesive, silver paste, or any other desired materials may be used to couple, secure, affix, attach, mount, and/or adhere conductive traces 83A to electrode 76B and to couple, secure, affix, attach, mount, and/or adhere conductive traces 83B to electrode 76A. In this way, tails 74A and 74B may be mechanically attached to tint layer 42 while also providing an electrical connection between control lines 66 (conductive traces 83A and 83B) and electrodes 76.

If desired, tails 74A and 74B may be laterally offset from each other. For example, as shown in FIG. 6, tails 74A and 74B may be partially or completely non-overlapping with respect to each other within cavity 82 between substrates 50A and 50B. This is illustrative and non-limiting. If desired, tails 74A and 74B may laterally overlap each other within cavity 82. In these configurations, if desired, adhesive, a spacer, or other materials may be used to couple tails 74A and 74B together. Cavity 82 may be filled with air or, if desired, some or all of cavity 82 may be filled with encapsulant 84 (e.g., tails 74A and 74B may be embedded within encapsulant 84). Encapsulant 84 may include molded plastic, epoxy, adhesive, resin, etc. Encapsulant 84 may help to maintain uniform thickness of tint layer 42, may help to maximize the mechanical strength of tint layer 42, may help to keep tails 74A and 74B secured in place over time, may help to prevent moisture, oxidation, or contaminants from affecting the connection between tails 74 and electrodes 76, and/or may help to prevent oxygen and/or moisture from impinging on electrochromic gel 78, as examples. Disposing conductive traces 83A and 83B on different tails 74 may help to increase the overall flatness of substrates 50A and 50B (e.g., by avoiding the need for providing a flexible printed circuit with thickness T of FIG. 6).

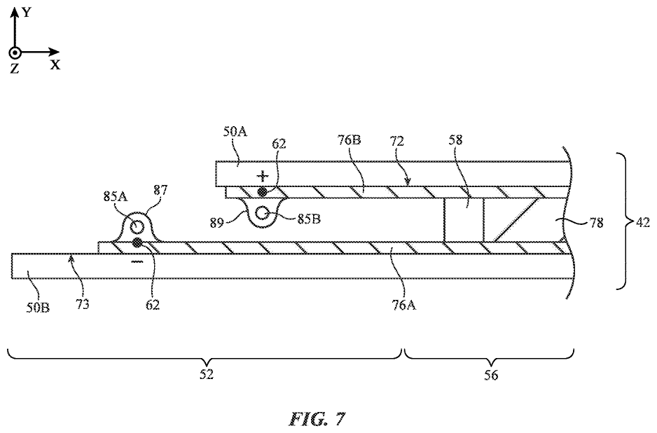

The examples of FIGS. 3, 5, and 6 in which control lines 66 are implemented using conductive traces 83 on one or more flexible printed circuits 60 are illustrative and non-limiting. If desired, control lines 66 may be implemented using conductive wires. FIG. 7 is a cross-sectional top view showing one example in which control lines 66 are implemented using conductive wires. As shown in FIG. 7, control lines 66 may be implemented using a first conductive wire 85A and a second conductive wire 85B. Conductive wire 85A may be electrically coupled and mechanically affixed/attached to electrode 76B using solder 89. Conductive wire 85B may be electrically coupled and mechanically affixed/attached to electrode 76A using solder 87.

If desired, conductive wires 85A and 85B may be bundled together (e.g., using wire insulation or packaging) and then separated at tint layer 42 to couple the wires to electrodes 76A and 76B. If desired, silver paste or any other desired adhesion promoter may be used to help secure conductive wire 85A to electrode 76A in addition to solder 87 and to help secure conductive wire 85B to electrode 76B in addition to solder 89. If desired, control lines 66 may be implemented using both conductive wires and one or more flexible printed circuits (e.g., jumper flexes). For example, conductive wires 85A and 85B may couple driver 80 (FIG. 4) to conductive traces 83A on tail 74A and to conductive traces 83B on tail 74B of FIG. 6, respectively. As another example, conductive wires 85A and 85B may couple driver 80 to conductive traces 83A and conductive traces 83B, respectively, on tail 74 of FIG. 5. In these configurations the flexible printed circuit(s) are used to establish electrical and mechanical contact with substrates 50A and 50B whereas conductive wires 85 couple the flexible printed circuit(s) to the rest of the system.

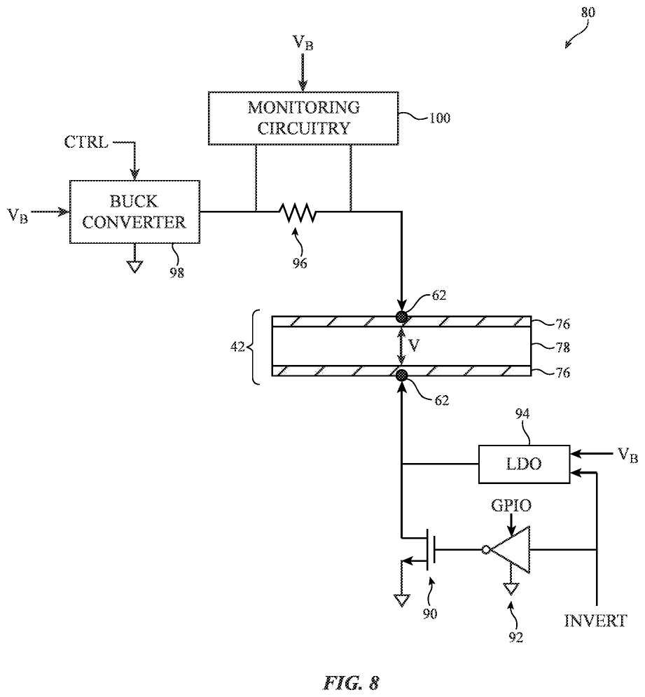

FIGS. 8-16 include circuit diagrams of driver 80 in implementations where driver 80 drives tint layer 42 using voltage V across electrodes 76 through control lines 66 (e.g., through control lines 66 of FIGS. 3 and 4, conductive traces 83 of FIGS. 5 and 6, and/or through conductive wires 85 of FIG. 7). In general, driver 80 may include any desired tint driver circuitry. FIG. 8 shows one example in which driver 80 includes a buck converter that drives a first electrode 76 and a low-dropout (LDO) regulator and an inverter that drive a second electrode 76 of tint layer 42.

As shown in FIG. 8, driver 80 may include a DC-to-DC (stepdown) converter such as buck converter 98, a monitoring circuit 100, a resistor 96, an LDO regulator 94, an inverter 92, and a transistor 90. Buck converter 98 may have an input that receives a DC reference voltage such as reference voltage V_{B} (e.g., a power supply voltage of system 10). Buck converter 98 may have a control input that receives control signal CTRL (e.g., from control circuitry 16 of FIG. 1). The output of buck converter 98 may be coupled to the first electrode 76 of tint layer 42 at a corresponding drive terminal 62 (e.g., over a first control line 66 of FIGS. 3 and 4). Resistor 96 may be coupled in series between the output of buck converter 98 and the first electrode 76. Monitoring circuit 100 may be coupled across resistor 96. Monitoring circuit 100 may also receive a DC reference voltage such as voltage V_{B}.

LDO regulator 94 may have an input that receives reference voltage V_{B} and an output coupled to the second electrode 76 of tint layer 42 at a corresponding terminal 62 (e.g., over a second control line 66 of FIGS. 3 and 4). LDO regulator 94 may also have a control input (e.g., an enable pin) that receives an inverter control signal INVERT from control circuitry 16 (FIG. 1). The input of inverter 92 may also receive inverter control signal INVERT. Inverter 92 may have a bias terminal that receives a digital signal GPIO (e.g., from control circuitry 16 of FIG. 1). The output of inverter 92 may be coupled to the gate terminal of transistor 90. Transistor 90 may have a first source/drain terminal coupled to the drive terminal 62 on the second electrode 76 of tint layer 42 and may have a second source/drain terminal coupled to ground.

Buck converter 98, LDO regulator 94, inverter 92, and transistor 90 may apply voltage V across the electrodes 76 of tint layer 42. Buck converter 98 may step down reference voltage V_{B} (e.g., may output a DC voltage onto the first electrode 76 generated based on reference voltage V_{B} but having a lower magnitude than reference voltage V_{B}). Buck converter 98 may be a tunable buck converter that steps down voltage V_{B} by a desired amount selected based on control signal CTRL. Put differently, control signal CTRL may control buck converter 98 to output a voltage of a desired magnitude (e.g., for applying a voltage V of a selected magnitude across electrodes 76).

At the same time, LDO regulator 94, inverter 92, and transistor 90 may drive the second electrode 76 of tint layer 42 (e.g., such that a voltage V of the selected magnitude is established across electrodes 76 and electrochromic gel 78). LDO regulator 94 may, for example, be a fixed LDO regulator. Monitoring circuit 100 may include current monitoring circuitry (e.g., an ammeter and/or an ADC) that measures the current flowing through resistor 96, voltage monitoring circuitry (e.g., a voltmeter) that measures voltage across resistor 96, and/or power monitoring circuitry that measures power produced by resistor 96. Control circuitry 16 (FIG. 1) may, for example, generate, deduce, infer, or output information identifying the temperature of tint layer 42 (sometimes referred to herein as temperature information) based on the current, voltage, and/or power measurements gathered or performed by monitoring circuit 100. Control circuitry 16 may then adjust the voltage V across tint layer 42 based on the temperature information (e.g., to mitigate or counteract any non-idealities in the transitions and transmission profile of tint layer 42 as a function of tint layer temperature). Additionally or alternatively, monitoring circuit 100 may measure the current sourced from the driver to identify or infer the tint state of tint layer 42 (e.g., to ensure that the actual tint state matches the expected tint state and/or to tweak the drive voltage as necessary to ensure that the tint layer exhibits the expected tint state using a feedback scheme). Monitoring circuit 100 and resistor 96 may be omitted if desired.

The example of FIG. 8 illustrates how driver 80 may drive a single tint layer 42. If desired, driver 80 may drive multiple tint layers 42 (e.g., a left tint layer 42L overlapping a left waveguide 32 in system 10 for presenting image content to a user's left eye and a right tint layer 42R overlapping a right waveguide 32 in system 10 for presenting image content to a user's right eye). In these implementations, the left and right tint layers may each have a first electrode 76 driven by a different respective buck converter. If desired, the second electrode 76 of the left and right tint layers may both be driven by the same LDO regulator 94, transistor 90, and inverter 92 (e.g., the output of LDO regulator 94 and the first source/drain terminal of transistor 90 may be coupled to the second electrode 76 of both the left and right tint layers).

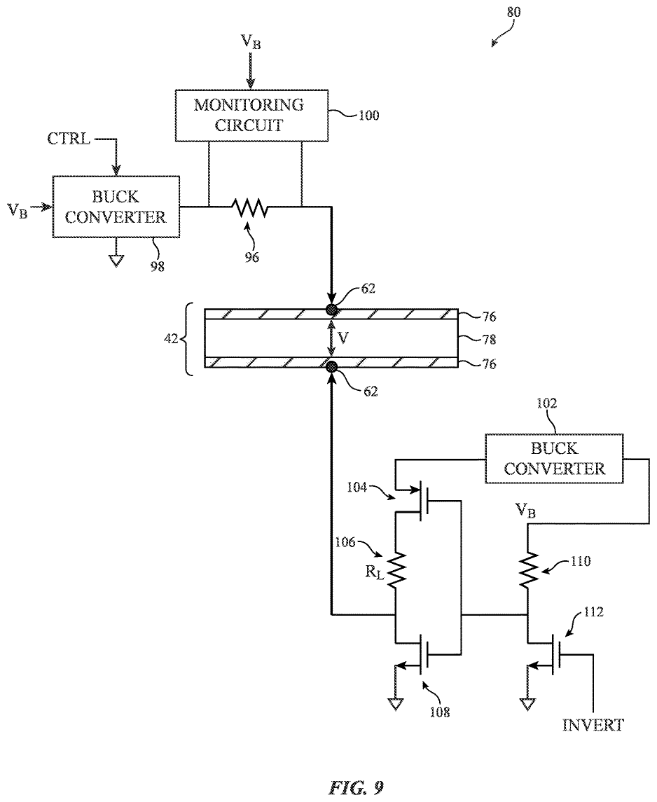

If desired, the second electrode 76 of tint layer 72 may be driven by an additional buck converter, as shown in the example of FIG. 9. As shown in FIG. 9, driver 80 may include a buck converter 102, a first transistor 104, a second transistor 108, a third transistor 112, a first resistor 106, and a second resistor 100. Transistors 104, 108, and 112 may serve as a pair of inverters coupled around buck converter 102.

Buck converter 102 may have an output coupled to a first source/drain terminal of transistor 104. Transistor 104 may have a second source/drain terminal coupled to a first terminal of resistor 106. Resistor 106 may be a limiting resistor having resistance R_{L}. Resistor 106 may have a second terminal coupled to a first source/drain terminal of transistor 108 and to the terminal 62 on the second electrode 76 of tint layer 42. Transistor 108 may have a second source/drain terminal coupled to ground.

Transistor 112 may have a gate terminal that receives inverter control signal INVERT. Transistor 112 may have a first source/drain terminal coupled to the input of buck converter 102 through resistor 110 (e.g., resistor 110 may be coupled in series between the first source/drain terminal of transistor 112 and the input of buck converter 102). Transistor 112 may have a second source/drain terminal coupled to ground. The gate terminal of transistor 104 and the gate terminal of transistor 108 may both be coupled to the first source/drain terminal of transistor 112 and may both be coupled to the input of buck converter 102 through resistor 110. The input of buck converter 102 may receive reference voltage V_{B}. When driving the second electrode of tint layer 42, buck converter 102 may step down reference voltage V_{B}. Resistor 106 may serve to prevent current overshoot (e.g., may limit current across the transistors and at the output of buck converter 102) to help protect the transistors and buck converter 102 in driver 80 from damage. Driving the second electrode 76 of tint layer 74 in this way may produce higher efficiency than driving the second electrode using LDO regulator 94 of FIG. 8, for example.

The example of FIG. 9 illustrates how driver 80 may drive a single tint layer 42. If desired, driver 80 may drive multiple tint layers 42 (e.g., a left tint layer 42L overlapping a left waveguide 32 in system 10 for presenting image content to a user's left eye and a right tint layer 42R overlapping a right waveguide 32 in system 10 for presenting image content to a user's right eye). In these implementations, the left and right tint layers may each have a first electrode 76 driven by a different respective buck converter. If desired, the second electrode 76 of the left and right tint layers may both be driven by the same buck converter 102, transistor 104, transistor 108, and transistor 112 (e.g., the output of buck converter 102 and the first source/drain terminal of transistor 108 may be coupled to the second electrode 76 of both the left and right tint layers).

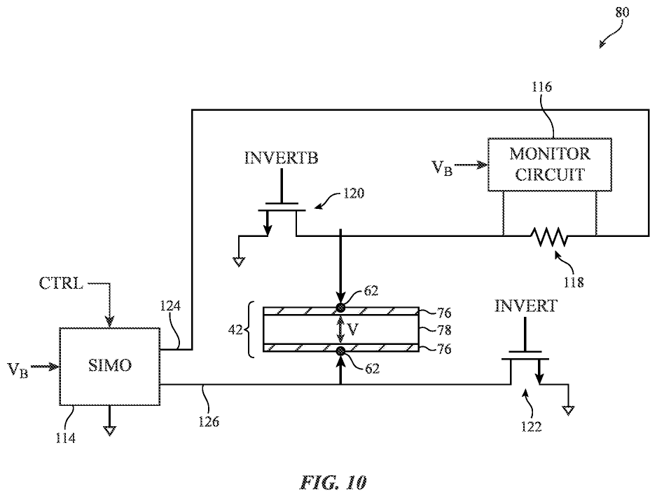

FIG. 10 shows one example in which driver 80 includes a single inductor multiple output (SIMO) buck converter that drives both the first electrode 76 and the second electrode 76 of tint layer 42. As shown in FIG. 10, driver 80 may include a SIMO buck converter 114, a first transistor 120, a second transistor 122, monitoring circuitry such as monitoring circuit 116, and resistor 118.

SIMO buck converter 114 may have an input that receives reference voltage V_{B} and may have a control input that receives control signal CTRL. SIMO buck converter 114 may have a first output 124 coupled to the first electrode 76 on tint layer 42 (e.g., over a first control line 66 of FIGS. 3 and 4). SIMO buck converter 114 may have a second output 126 coupled to the second electrode 76 on tint layer 42 (e.g., over a second control line 66 of FIGS. 3 and 4).

Resistor 118 may be coupled in series between first output 124 of SIMO buck converter 102 and the first electrode 76 of tint layer 42. Monitoring circuit 116 may be coupled across resistor 118 and may receive reference voltage V_{B}. Transistor 122 may have a first source/drain terminal coupled to second output 126 of SIMO buck converter 102 and the second electrode 76 of tint layer 42. Transistor 122 may have a second source/drain terminal coupled to ground and may have a gate terminal that receives inverter control signal INVERT. Transistor 120 may have a first source/drain terminal coupled to the terminal 62 on the first electrode 76 of tint layer 42 and may have a second source/drain terminal coupled to ground. The gate terminal of transistor 120 may receive an inverter control signal INVERTB from control circuitry 16 (FIG. 1).

SIMO buck converter 114 and inverter 120 may drive the first electrode 76 of tint layer 42. SIMO buck converter 114 and inverter 122 may drive the second electrode 76 of tint layer 42. SIMO buck converter 114 may be a tunable buck converter and may step down reference voltage V_{B} to a desired magnitude based on control signal CTRL such that a voltage V having a desired magnitude is produced across the electrodes 76 of tint layer 42. Monitoring circuit 116 may perform similar operations as monitoring circuit 100 of FIG. 8. If desired, monitoring circuit 116 and resistor 118 may be omitted.

The example of FIG. 10 illustrates how driver 80 may drive a single tint layer 42. If desired, driver 80 may drive multiple tint layers 42 (e.g., a left tint layer 42L overlapping a left waveguide 32 in system 10 for presenting image content to a user's left eye and a right tint layer 42R overlapping a right waveguide 32 in system 10 for presenting image content to a user's right eye). In these implementations, the left and right tint layers may each have a first electrode 76 driven by second output 126 and transistor 122. On the other hand, the left and right tint layers may be driven first output 124 of SIMO buck converter 114 (or first and third outputs of SIMO buck converter 114) and different respective transistors 120. Driving tint layer(s) 42 using SIMO buck converter 114 may configure driver 80 to consume less space in system 10 than in the configurations of FIGS. 8 and 9, for example.

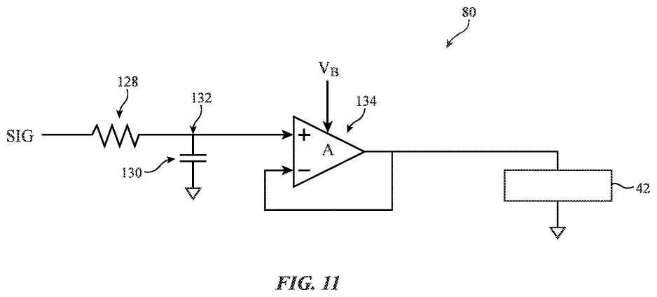

FIG. 11 shows one example in which driver 80 includes an analog buffer that drives both electrodes 76 of tint layer 42. As shown in FIG. 11, driver 80 may include an analog buffer such as buffer 134, a resistor 128, and a capacitor 130. Resistor 128 may have a first terminal that receives a control signal SIG (e.g., a GPIO signal provided with pulse width modulation (PWM)) and may have a second terminal coupled to a first (e.g., positive) input of buffer 134. Capacitor 130 (e.g., a filtering or coupling capacitor) may be coupled between the second terminal of resistor 128, the first input of buffer 134, and ground.

The output of buffer 134 may be coupled to a second (e.g., negative) input of buffer 134. Buffer 134 may have a bias terminal that receives reference voltage V_{B}. The output of buffer 134 may be coupled to the electrode(s) of tint layer 42. If desired, the output of buffer 134 may be coupled to a first electrode of tint layer 42 whereas the second electrode of tint layer 42 is coupled to ground. If desired, a resistor and monitoring circuit (e.g., resistor 96 and monitoring circuit 100 of FIG. 8) may be disposed on the control line between the output of buffer 134 and tint layer 42.

Buffer 134 may drive both electrodes of tint layer 42. For example, PWM of control signal SIG may be used to effectively produce a selected magnitude of voltage V driven across the electrodes of tint layer 42 by buffer 134. Driving tint layer 42 in this way may, for example, exhibit greater voltage accuracy than the configurations of FIGS. 8-10.

The example of FIG. 11 illustrates how driver 80 may drive a single tint layer 42. If desired, driver 80 may drive multiple tint layers 42 (e.g., a left tint layer 42L overlapping a left waveguide 32 in system 10 for presenting image content to a user's left eye and a right tint layer 42R overlapping a right waveguide 32 in system 10 for presenting image content to a user's right eye). In these implementations, the first electrode of the left and right tint layers may be coupled to different respective analog buffers 134 that each receive a different respective control signal SIG. The second electrode of the left and right tint layers may be coupled together and/or to ground.

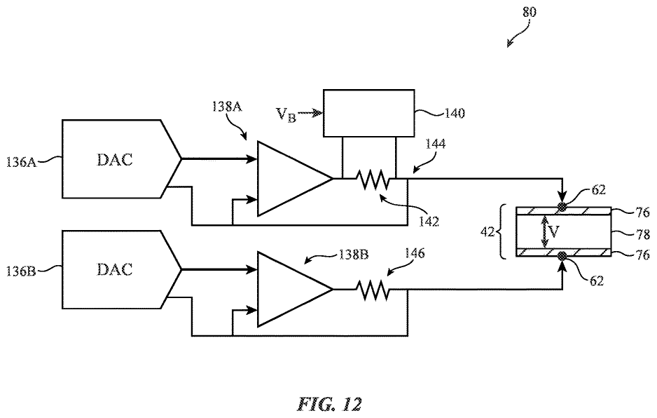

FIG. 12 shows one example in which driver 80 includes different respective digital-to-analog converters (DACs) and analog buffers for driving the first and second electrodes 76 of tint layer 42. As shown in FIG. 12, driver 80 may include a first analog buffer such as buffer 138A, a first DAC 136A, a second DAC 136B, a second analog buffer such as buffer 138B, a monitoring circuit 140, and a resistor 142.

DAC 136A may have an output coupled to the first input of buffer 138A. DAC 136A may have an input coupled to the second input of buffer 138A and to circuit node 144. Circuit node 144 may be coupled to the output of buffer 138A through resistor 142. Monitoring circuit 140 may be coupled across resistor 142. Circuit node 144 may be coupled to the terminal 62 on the first electrode 76 of tint layer 42.

DAC 136B may have an output coupled to the first input of buffer 138B. DAC 136B may have an input coupled to the second input of buffer 138B and to circuit node 146. The output of buffer 138B may be coupled to circuit node 146 and may be coupled to the terminal 62 on the second electrode 76 of tint layer 42 through circuit node 146.

During operation, DAC 136A and buffer 138A may drive the first electrode 76 of tint layer 42. DAC 136B and buffer 138B may drive the second electrode 76 of tint layer 42. This may produce a voltage V having a selected magnitude between the first and second electrodes 76 of tint layer 42. Monitoring circuit 140 may perform similar operations as monitoring circuit 100 of FIG. 8. If desired, monitoring circuit 140 and resistor 142 may be omitted.

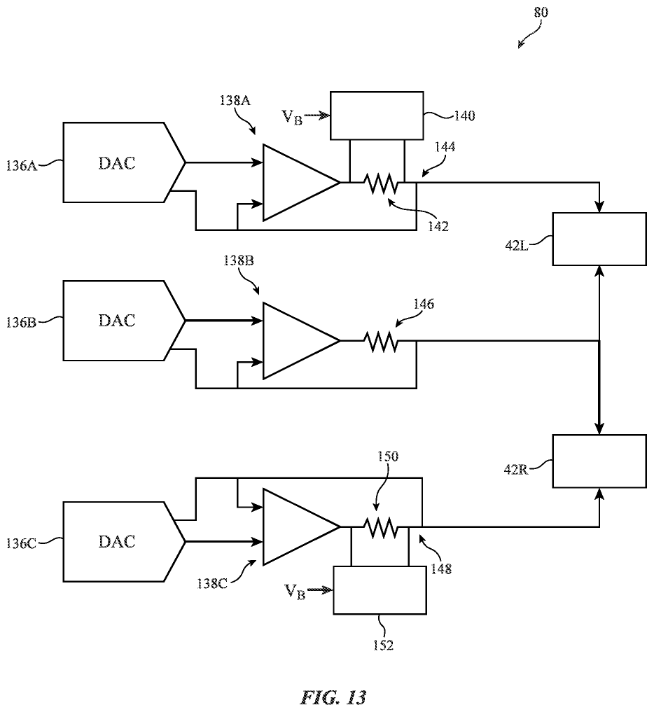

The example of FIG. 12 illustrates how driver 80 may drive a single tint layer 42. If desired, driver 80 may include three DACs 136 and three buffers 138 that drive multiple tint layers 42 (e.g., a left tint layer 42L overlapping a left waveguide 32 in system 10 for presenting image content to a user's left eye and a right tint layer 42R overlapping a right waveguide 32 in system 10 for presenting image content to a user's right eye). FIG. 13 shows one example of how driver 80 may include three DACs 136 and three buffers 138 that drive a left tint layer 42L and a right tint layer 42R.

As shown in FIG. 13, circuit node 146 may couple the output of buffer 138B to both the second electrode of left tint layer 42L and the first electrode of right tint layer 42R. Driver 80 may further include a third analog buffer such as buffer 138C, a third DAC 136C, an additional monitoring circuit 152, and an additional resistor 150.

DAC 136C may have an output coupled to the first input of buffer 138C. DAC 136C may have an input coupled to the second input of buffer 138C and to circuit node 148. Circuit node 148 may be coupled to the output of buffer 138C through resistor 150. Monitoring circuit 152 may be coupled across resistor 150. Circuit node 148 may be coupled to the second electrode of right tint layer 42R.

During operation, DAC 136A and buffer 138A may drive the first electrode of left tint layer 42. DAC 136B and buffer 138B may drive the second electrode of left tint layer 42L and the first electrode of right tint layer 42R. DAC 136C and buffer 138C may drive the second electrode of right tint layer 42R. This may produce voltages V having selected magnitudes across left tint layer 42L and right tint layer 42R. Monitoring circuits 140 and 152 may perform similar operations as monitoring circuit 100 of FIG. 8. If desired, monitoring circuit 140, resistor 142, monitoring circuit 152, and/or resistor 150 may be omitted.

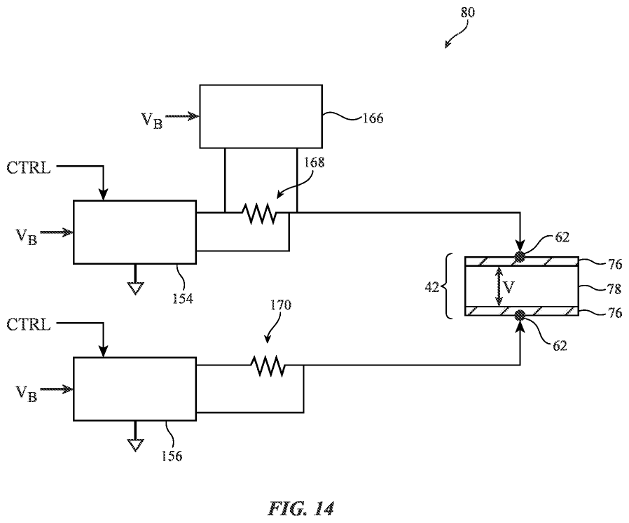

More generally, driver 80 may include tunable circuit blocks for driving the first and second electrodes of tint layer 42, respectively, as shown in the example of FIG. 14. As shown in FIG. 14, driver 80 may include a first tunable circuit block 154, a second tunable circuit block 156, resistor 168, monitoring circuit 166, and resistor 170.

Tunable circuit block 154 may have an input that receives reference voltage V_{B}, a control input that receives control signal CTRL, and first and second outputs coupled to the terminal 62 on the first electrode 76 of tint layer 42. Resistor 168 may be coupled between the first and second outputs of tunable circuit block 154. Monitoring circuit 166 may be coupled across resistor 168.

Tunable circuit block 156 may have an input that receives reference voltage V_{B}, a control input that receives control signal CTRL, and first and second outputs coupled to the terminal 62 on the second electrode 76 of tint layer 42. Resistor 170 may be coupled between the first and second outputs of tunable circuit block 156 or may be omitted. If desired, a monitoring circuit (not shown) may be coupled across resistor 170 or may be omitted.

Tunable circuit block 154 may include a tunable buck converter (e.g., buck converter 98 of FIG. 8), an LDO regulator (e.g., LDO regulator 94 of FIG. 8), or a DAC and analog buffer (e.g., a DAC 136 and a corresponding buffer 138 of FIG. 12). Tunable circuit block 156 may include a tunable buck converter (e.g., buck converter 98 of FIG. 8), an LDO regulator (e.g., LDO regulator 94 of FIG. 8), or a DAC and analog buffer (e.g., a DAC 136 and a corresponding buffer 138 of FIG. 12).

During operation, tunable circuit 154 may drive the first electrode 76 of tint layer 42. Tunable circuit block 156 may drive the second electrode 76 of tint layer 42. Control signal CTRL may control tunable circuit blocks 154 and 156 to set the magnitude of the voltage V drive across the electrodes 76 of tint layer 42. Monitoring circuit 166 may perform similar operations as monitoring circuit 100 of FIG. 8. If desired, monitoring circuit 166, resistor 168, and/or resistor 170 may be omitted.

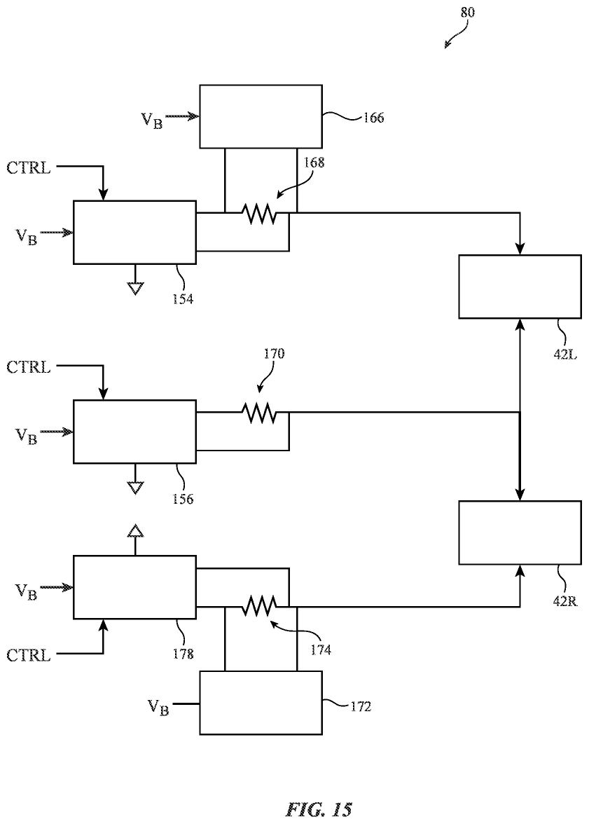

The example of FIG. 15 illustrates how driver 80 may drive a single tint layer 42. If desired, driver 80 may include three tunable circuits that drive multiple tint layers 42 (e.g., a left tint layer 42L overlapping a left waveguide 32 in system 10 for presenting image content to a user's left eye and a right tint layer 42R overlapping a right waveguide 32 in system 10 for presenting image content to a user's right eye). FIG. 15 shows one example of how driver 80 may include three tunable circuits that drive a left tint layer 42L and a right tint layer 42R.

As shown in FIG. 15, the outputs of tunable circuit block 156 may be coupled to both the second electrode of left tint layer 42L and the first electrode of right tint layer 42R. Driver 80 may further include a third tunable circuit block such as circuit block 178, an additional resistor 174, and an additional monitoring circuit 172. Tunable circuit blocks 154, 156, and 178 may sometimes also be referred to herein more simply as tunable circuit blocks 154, 156, and 178.

Tunable circuit block 156 may have an input that receives reference voltage V_{B}, a control input that receives control signal CTRL, and first and second outputs coupled to the second electrode of right tint layer 42R. Resistor 174 may be coupled between the first and second outputs of tunable circuit block 178 or may be omitted. Monitoring circuit 172 may be coupled across resistor 174. Tunable circuit block 178 may include a tunable buck converter (e.g., buck converter 98 of FIG. 8), an LDO regulator (e.g., LDO regulator 94 of FIG. 8), or a DAC and analog buffer (e.g., a DAC 136 and a corresponding buffer 138 of FIG. 12). If desired, one or more of tunable circuit blocks 154, 156, and/or 178 may include the analog buffer that receives the PWM signal SIG of FIG. 11 (e.g., the tunable circuit block may be tuned or adjusted by adjusting the PWM of signal SIG).

During operation, tunable circuit block 154 may drive the first electrode of left tint layer 42, tunable circuit block 156 may drive the second electrode of left tint layer 42L and the first electrode of right tint layer 42R, and tunable circuit block 178 may drive the second electrode of right tint layer 42R. This may produce voltages V having selected magnitudes across left tint layer 42L and right tint layer 42R. Monitoring circuits 166 and 172 may perform similar operations as monitoring circuit 100 of FIG. 8. If desired, monitoring circuit 166, resistor 168, monitoring circuit 172, and/or resistor 174 may be omitted.

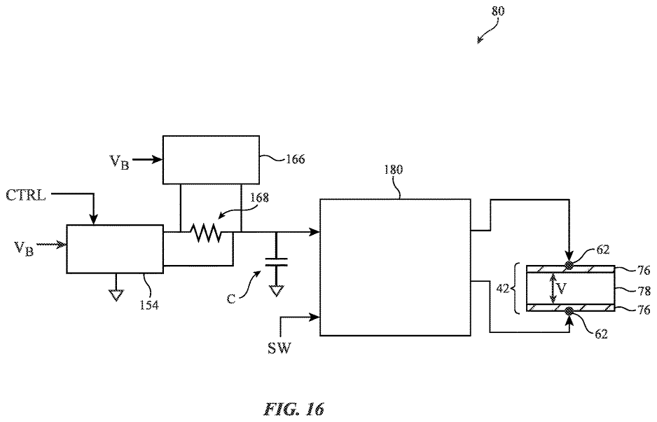

FIG. 16 shows another example in which driver 80 drives both electrodes 76 of tint layer 42 using a tunable circuit block and an H-bridge circuit. As shown in FIG. 16, driver 80 may an H-bridge circuit such as H-bridge 180. H-bridge 180 may have an input coupled to the output of tunable circuit block 154. H-bridge 180 may have a first output coupled to the terminal 62 of the first electrode 76 of tint layer 42 and may have a second output coupled to the terminal 62 of the second electrode 76 of tint layer 42. A capacitor C may be coupled between the first input of H-bridge 180 and ground. H-bridge 180 may have one or more control inputs that receive switch control signals SW. During operation, tunable circuit block 154 and H-bridge 180 may drive both electrodes of tint layer 42 to produce a selected magnitude of voltage V across the electrodes 76 of tint layer 42. Monitoring circuit 166 and resistor 168 may be omitted if desired.

The examples of FIGS. 8-16 are illustrative and non-limiting. In general, driver 80 may have any desired driver circuitry. The configurations of FIGS. 8-16 may be combined if desired. The same driver 80 may drive both left and right tint layers or separate drivers 80 may drive the left and right tint layers independently.

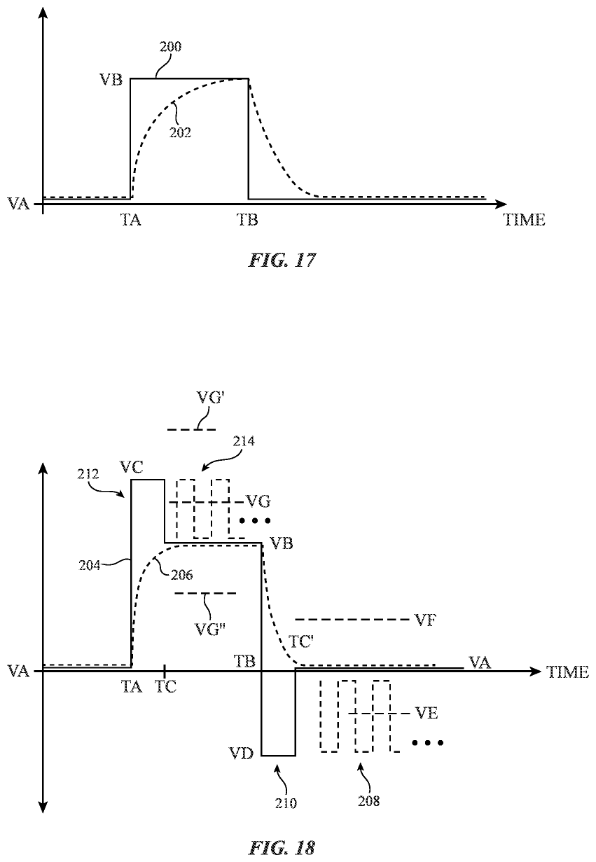

FIGS. 17-20 are timing diagrams of illustrative voltage waveforms (e.g., voltage V across the electrodes 76 of tint layer 42) that may be generated by driver 80 of FIGS. 4 and 8-16 to drive tint layer 42. FIG. 17 shows an example of a binary voltage waveform that may be used to drive tint layer 42.

As shown in FIG. 17, curve 200 plots the voltage V across tint layer 42 as a function of time. Curve 202 plots the corresponding tint response (e.g., opacity or tint level) of tint layer 42 when driven by voltage V. Tint layer 42 is in a clear state (e.g., electrochromic gel 78 exhibits maximal light transmission) when provided with a voltage V having a magnitude of 0 V. Tint layer 42 is in a dark state (e.g., electrochromic gel 78 exhibits minimal light transmission) when voltage V is provided at a peak magnitude. Higher magnitudes of curve 202 therefore correspond to higher tint levels or levels of opacity whereas a zero magnitude of curve 202 corresponds to a minimal tint level or level of opacity (e.g., tint layer 42 may be transparent when at minimal tint level).

As shown by curves 200 and 202, tint layer 42 may be in the clear state while voltage V has a magnitude VA (e.g., VA=0 V). At time TA, driver 80 may pulse voltage V to magnitude VB. This may cause tint layer 42 to transition to the dark state (e.g., in a quasi-steady state). In practice, the transition in opacity of tint layer 42 in transitioning to the dark state may lag behind voltage V over time. At time TB, voltage V may drop back to magnitude VA and tint layer 42 may return to the clear state. In practice, the transition in opacity of tint layer 42 in transitioning to the clear state may lag behind voltage V over time. The magnitude of VA can be adjusted to choose the desired tint level of tint layer 42. The level of light transmission by tint layer 42 may be tuned by adjusting voltage V once in the steady (or quasi-steady) state. In general, higher transmission can reduce leakage current/holding power required to keep the tint layer in that state.

The binary driving scheme of FIG. 17 represents the simplest driving scheme for tint layer 42. If desired, driver 80 may overdrive tint layer 42 to accelerate the transition time of the tint layer. FIG. 18 shows an example of how driver 80 may overdrive tint layer 42. As shown in FIG. 18, curve 204 plots the voltage V across tint layer 42 as a function of time. Curve 206 plots the corresponding tint response (e.g., opacity or tint level) of tint layer 42 when driven by voltage V.

As shown by curves 204 and 206, tint layer 42 may be in the clear state while voltage V has a magnitude VA (e.g., VA=0 V) prior to time TA. At time TA, driver 80 may pulse voltage V. Rather than pulsing voltage V to magnitude VB (as in FIG. 17), driver 80 may overdrive tint layer 42 by pulsing voltage V to a magnitude VC greater than magnitude VB (e.g., as shown by overdrive pulse 212). At time TC, driver 80 may reduce voltage V to magnitude VB (e.g., ending overdrive pulse 212). Driver 80 may continue to assert voltage V at magnitude VB until time TB.

As shown by curve 206, overdriving voltage V using overdrive pulse 212 may serve to reduce the time required for tint layer 42 to transition from transparent to peak tint level or opacity (e.g., curve 206 reaches peak magnitude in less time than when voltage V is not overdriven). Magnitude VC may be sufficiently high to accelerate the opacity transition of tint layer 42 by the desired amount but not so high as to cause damage to tint layer 42 or to drive unwanted electrochemical reactions in electrochromic gel 78. The duration between times TA and TC (e.g., the duration of overdrive pulse 212) may be selected to accelerate the transition of tint layer 42 without causing a tint state overshoot.

If desired, driver 80 may drive tint layer 42 with multiple consecutive overdrive pulses (e.g., using one or more additional overdrive pulses 214). Additional overdrive pulses 214 may be at magnitude VC, may be at one or more intermediate magnitudes VG less than magnitude VC and greater than magnitude VB, may be at one or more magnitudes VG′ greater than magnitude VC, and/or may be at one or more magnitudes VG″ less than magnitude VB but greater than magnitude VA. Overdrive pulse 212 and each additional overdrive pulse 214 may be separated by a voltage at magnitude VB, a voltage at magnitude VG, a voltage at magnitude VG′, a voltage at magnitude VA, and/or any other desired voltage levels. Each additional overdrive pulse 214 may have the same magnitude or different additional overdrive pulses 214 may have different magnitudes. Each additional overdrive pulse 214 may have the same duration or different additional overdrive pulses 214 may have different durations. If desired, the number of additional overdrive pulses 214 and the duration of overdrive pulse 212 and additional overdrive pulse(s) 214 may be selected (e.g., effectively duty-cycled) to fine tune the response time of the tint layer. If desired, the electrodes of tint layer 42 may be floated (e.g., by controlling switch 81 of FIG. 4 to form an open circuit) at one or more times between or during overdrive pulse 212 and/or additional overdrive pulses 214 (e.g., to reduce power consumption).

To accelerate the transition of tint layer 42 from the dark state back to the transparent state, rather than returning voltage V to magnitude VB at time TB (as in FIG. 17), driver 80 may underdrive tint layer 42 by pulsing voltage V to a negative magnitude VD that is less than magnitude VA (e.g., as shown by underdrive pulse 210). At time TC′, driver 80 may increase voltage V back to magnitude VA (e.g., ending underdrive pulse 210).

As shown by curve 206, under-driving voltage V using underdrive pulse 210 may serve to reduce the time required for tint layer 42 to transition from the dark state back to the clear state (e.g., curve 206 returns to minimal magnitude in less time than when voltage V is not underdriven). The duration between times TB and TC′ (e.g., the duration of underdrive pulse 210) may be selected to accelerate the transition or clearing of tint layer 42 without causing a tint state overshoot.

If desired, driver 80 may drive tint layer 42 with multiple consecutive pulses when transitioning back to the clear state (e.g., using one or more additional pulses 208). Additional pulses 208 may be underdrive pulses at magnitude VD, may be at one or more intermediate underdrive magnitudes VE less than magnitude VA and greater than magnitude VD, or may be at one or more positive magnitudes VF greater than magnitude VA. Underdrive pulse 210 and each of pulses 208 may be separated by a voltage at magnitude VA, a voltage at magnitude VE, a voltage at magnitude VF, and/or any other desired voltage levels. Each pulse 208 may have the same magnitude or different pulses 208 may have different magnitudes. Each pulse 208 may have the same duration or different pulses 208 may have different durations. If desired, the number of pulses 208 and the duration of underdrive pulse 210 and pulse(s) 208 may be selected (e.g., effectively duty-cycled) to fine tune the response time of the tint layer. If desired, the electrodes of tint layer 42 may be floated (e.g., by controlling switch 81 of FIG. 4 to form an open circuit) at one or more times between or during underdrive pulse 210 and/or pulses 208 (e.g., to reduce power consumption).

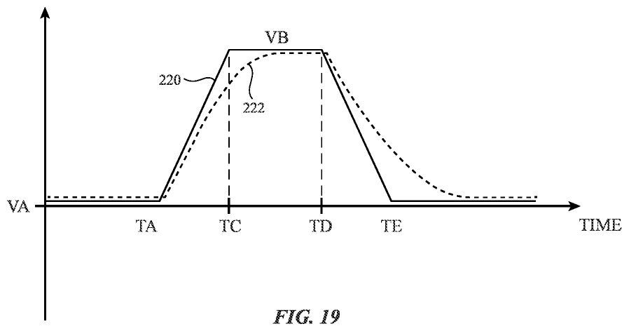

If desired, driver 80 may reduce the slew rate of voltage V to slow the transition of tint layer 42 between clear and dark states, as shown by the timing diagram of FIG. 19. As shown in FIG. 19, curve 220 plots the voltage V across tint layer 42 as a function of time. Curve 222 plots the corresponding tint response (e.g., opacity or tint level) of tint layer 42 when driven by voltage V.

As shown by curves 220 and 222, tint layer 42 may be in the clear state while voltage V has a magnitude VA (e.g., VA=0 V) prior to time TA. At time TA, driver 80 may begin to increase voltage V until voltage V has magnitude VB at time TC. Rather than increasing voltage V as instantaneously as possible, driver 80 may slowly increase voltage V such that voltage V increases at the slew rate (slope) of (VB−VA)/(TC−TA). This may cause tint layer 42 to slowly (gradually) transition from the clear state to the dark state.

Similarly, at time TD, driver 80 may begin to decrease voltage V until voltage V has magnitude VA at time TE. Rather than decreasing voltage V as instantaneously as possible, driver 80 may slowly decrease voltage V such that voltage V decreases at the slew rate (slope) of (VB−VA)/(TE−TD). This may cause tint layer 42 to slowly (gradually) transition from the dark state to the clear state. The slew rate (slope) at the leading edge of the pulse in FIG. 19 may have the same magnitude as the slew rate (slope) at the falling edge of the pulse in FIG. 19 or may have a different magnitude. Alternatively, tint driving can be performed by constant current driving to produce a gradual transition.

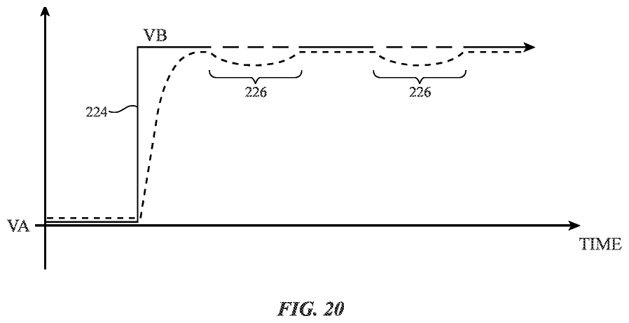

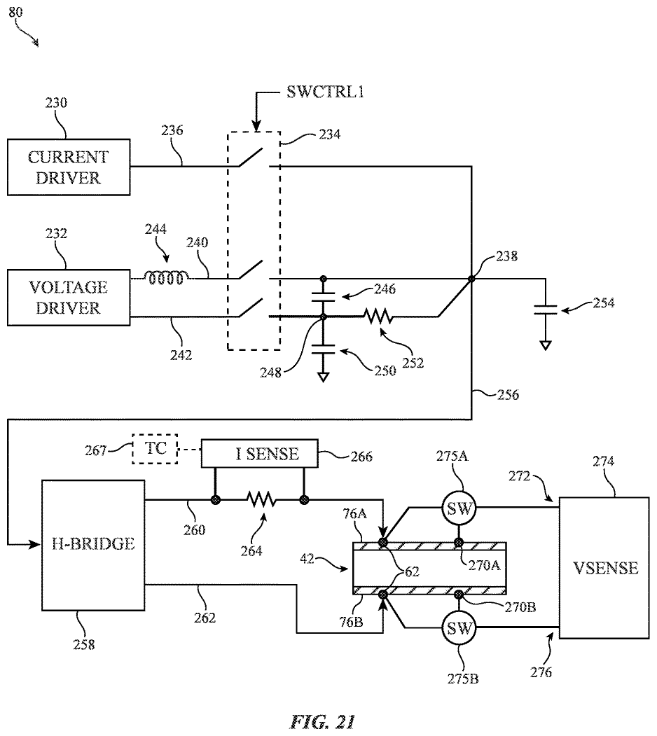

If desired, tint layer 42 may be periodically floated relative to driver 80 at one or more times. FIG. 20 is a timing diagram showing one example of how tint layer 42 may be periodically floated while in the dark state. As shown in FIG. 20, curve 224 plots the voltage V across tint layer 42 as a function of time. Curve 222 plots the corresponding tint response (e.g., opacity or tint level) of tint layer 42 when driven by voltage V.

As shown in FIG. 20, rather than continuing to assert voltage V at magnitude VB across the electrodes of tint layer 42 once in the dark state, switch 81 (FIG. 4) may decouple driver 80 from the terminals 62 of tint layer 42 (e.g., by interposing an open circuit on control lines 66) during one or more periods 226. During each period 226, the electrodes 76 of tint layer 42 are decoupled from driver 80 and are electrically floating with respect to driver 80. During periods 226, tint layer 42 will slowly begin to clear (e.g., reduce opacity or tint level) due to diffusion in electrochromic gel 78. However, after a given period 226 has ended, switch 81 re-couples driver 80 to the terminals 62 of tint layer 42, re-asserting voltage V at magnitude VB across electrodes 76 and causing the tint layer to re-darken. Periodically floating electrodes 76 in this way may cause tint layer 42 to consume less overall current and power than continuously maintaining voltage V across electrodes 76 since there is no migration current in tint layer 42 during periods 226. The duration and frequency of periods 226 may be selected in a manner that makes the brief reduction in darkness of tint layer 42 unnoticeable to a user, while effectively reducing the overall power consumption of system 10. If desired, voltage V can also be duty cycled (e.g., using PWM) between two or more magnitudes in any tint state, which may effectively supply a different or intermediate voltage across the electrodes of tint layer 42.

The examples of FIGS. 4 and 8-20 in which driver 80 drives tint layer 42 using voltage V is illustrative and non-limiting. If desired, driver 80 may drive tint layer 42 using a drive current instead of a drive voltage. In these implementations, driver 80 may provide a drive current that flows between electrodes 76 and through electrochromic gel 78. Driver 80 may provide the drive current at different current magnitudes to set and/or adjust the state or transparency of tint layer 42 (e.g., electrochromic gel 78 may exhibit different levels of opacity based on the drive current flowing between electrodes 76 through the electrochromic gel).

If desired, driver 80 may switch between driving tint layer 42 using voltage V and driving tint layer 42 using a drive current. For example, driver 80 may be operable or switchable between a voltage drive mode (state) and a current drive mode (state). In the voltage drive mode, voltage driver circuitry in driver 80 drives tint layer 42 using voltage V. In the current drive mode, current driver circuitry in driver 80 drives tint layer 42 using a drive current.

FIG. 21 is a circuit diagram showing one example of how driver 80 may include both voltage driver circuitry and current driver circuitry for driving tint layer 42. As shown in FIG. 21, driver 80 may include current driving circuitry such as current driver 230 and may include voltage driving circuitry such as voltage driver 232. Driver 80 may also include an H-bridge circuit such as H-bridge 258. H-bridge 258 may communicatively couple both current driver 230 and voltage driver 232 to both electrodes 76A and 76B of tint layer 42.

Current driver 230 is sometimes also referred to herein as current drive circuit 230. Current driver 230 may be, for example, a current digital-to-analog converter (IDAC) or another type of current driving circuit. Current driver 230 may output a constant drive current onto path 236. Current driver 230 may be a tunable current driver (e.g., a tunable IDAC) that receives a control signal (not shown) that controls the current driver to adjust the magnitude of the drive current on path 236 over time.

Voltage driver 232 is sometimes also referred to herein as voltage drive circuit 232. Voltage driver 232 may be, for example, a buck converter, an LDO regulator, a SIMO buck converter, a DAC and analog buffer, or another type of voltage drive circuit. Voltage driver 232 may output a constant voltage V on paths 240 and 242. Voltage driver 232 may be a tunable voltage driver that receives a control signal (not shown) that controls the voltage driver to adjust the magnitude of voltage V over time.

Path 236 may be coupled to paths 240 and 242 at circuit node 238. There may be a load capacitance 254 coupled between circuit node 238 and ground. Driver 80 may include a path 256 that couples circuit node 238 to the input of H-bridge 258. H-bridge 258 may have a first output coupled to a first drive terminal 62 on electrode 76A over path 260. H-bridge 258 may have a second output coupled to a second drive terminal 62 on electrode 76B over path 262. A resistance such as resistor 264 may be disposed on path 260. Paths 260 and 262 may form control paths 66 of FIG. 3, for example.

Driver 80 may include an inductor 244 disposed on path 240 between voltage driver 232 and circuit node 238. If desired, driver 80 may include filter circuitry such as a first capacitor 246 coupled between path 240 and circuit node 248 on path 242, a second capacitor 250 coupled between circuit node 248 and ground, and/or resistor 252 (e.g., for forming a low pass filter between voltage driver 232 and circuit node 238 to prevent drive current output by current driver 230 from passing to voltage driver 232).

Driver 80 may be operable in a first operating mode (state) in which current driver 230 outputs a drive current that drives tint layer 42. The first operating mode is sometimes also referred to herein as a current drive mode or state. Driver 80 may also be operable in a second operating mode (state) in which voltage driver 232 drives tint layer 42 using voltage V. The second operating mode is sometimes also referred to herein as a voltage drive mode or state. Driver 80 may be switchable between the current drive mode and the voltage drive mode over time.

Driver 80 may include switching circuitry such as switching circuitry 234 disposed on paths 236, 240, and 242 (e.g., between current driver 230, voltage driver 232, and circuit node 238). Switching circuitry 234 may include respective switches disposed on paths 236, 240, and 242 (e.g., single-pole single-throw switches, transistors, etc.) and/or any other desired switches that selectively couple either current driver 230 or voltage driver 232 to circuit node 238 at a given time. Switching circuitry 234 may receive a switch control signal SWCTRL1 (e.g., from control circuitry 16 of FIG. 1) that controls the state of switching circuitry 234. The control circuitry may control the state of switching circuitry 234 to place driver 80 in the voltage drive mode or the current drive mode.

For example, switching circuitry 234 may be in a first state while driver 80 is in the current drive mode and may be in a second state while driver 80 is in the voltage drive mode. In the first state (e.g., when driver 80 is in the current drive mode), switching circuitry 234 couples current driver 230 to circuit node 238 (e.g., forming a short circuit impedance or less than a threshold impedance between current driver 230 and circuit node 238) while decoupling voltage driver 232 from circuit node 238 (e.g., forming an open circuit impedance or greater than a threshold impedance between voltage driver 232 and circuit node 238). Current driver 230 outputs a drive current on path 236, which flows onto path 236 through switching circuitry 234 and circuit node 238. H-bridge 258 then drives tint layer 42 using the drive current. The drive current flows between the drive terminal 62 on electrode 76A and the drive terminal 62 on electrode 76B through tint layer 42. The magnitude of the drive current configures the electrochromic gel in tint layer 42 to exhibit a corresponding transmission profile (e.g., tint level, opacity, and/or color response). Since voltage driver 232 is decoupled from circuit node 238 by switching circuitry 234, voltage V is not used to drive tint layer 42 while driver 80 is in the current drive mode.

On the other hand, in the second state of switching circuitry 234 (e.g., when driver 80 is in the voltage drive mode), switching circuitry 234 couples voltage driver 232 to circuit node 238 (e.g., forming a short circuit impedance or less than a threshold impedance between voltage driver 232 and circuit node 238) while decoupling current driver 230 from circuit node 238 (e.g., forming an open circuit impedance or greater than a threshold impedance between current driver 230 and circuit node 238). Voltage driver 232 outputs voltage V on paths 242 and 240, which is then passed to H-bridge 258. H-bridge 258 then drives tint layer 42 by establishing voltage V between the drive terminals 62 on electrodes 76A and 76B. Since current driver 230 is decoupled from circuit node 238 by switching circuitry 234, the drive current is not used to drive tint layer 42 while driver 80 is in the voltage drive mode. Driver 80 may be switched between the voltage drive mode and the current drive mode over time. For example, driver 80 may switch between the voltage drive mode and the current drive mode at least once during a given transition of tint layer 42 from a first tint/opacity level to a second tint/opacity level, at least once after tint layer 42 has entered a steady state at a given tint/opacity level, and/or based on the operating conditions of the display over time.

Driving tint layer 42 using the drive current (e.g., driver 80 in the current drive mode) may, for example, help to minimize the transition time of tint layer 42 from the first tint/opacity level to the second tint/opacity level. On the other hand, driving tint layer 42 using voltage V (e.g., driver 80 in the voltage drive mode) may be more controllable, stable, and/or simple to implement than driving tint layer 42 using the drive current.

The example of FIG. 21 in which driver 80 includes both voltage driver 232 and current driver 230 is illustrative and non-limiting. If desired, current driver 230, switching circuitry 234, and path 236 may be omitted so that driver 80 only drives tint layer 42 using voltage driver 232. Alternatively, voltage driver 232, inductor 244, paths 240 and 242, switching circuitry 234, capacitor 246, resistor 252, and capacitor 250 may be omitted so that driver 80 only drives tint layer 42 using current driver 230. If desired, switching circuitry 234 may include one or more switch states in which both current driver 230 and voltage driver 232 are coupled to circuit node 238 so that tint layer 42 is driven using both the drive current and voltage V at the same time. Alternatively, switching circuitry 234 may be omitted. In these implementations, both current driver 230 and voltage driver 232 may drive tint layer 42 at the same time or current driver 230 or voltage driver 232 may be selectively deactivated or powered down so that only one of current driver 230 and voltage driver 232 drives tint layer 42 at a given time.

In general, the electrical charge present (e.g., stored) within the electrochromic gel of tint layer 42 determines the tint/opacity level of tint layer 42. Both the drive current and voltage V affect the magnitude of charge in tint layer 42 and thus the tint/opacity level of tint layer 42. Driver 80 may include monitor circuits (e.g., monitor circuits 100, 116, 140, 152, 166, and 172 of FIGS. 8-16) that monitor or sense the charge, current, and/or voltage of tint layer 42 in real time. Control circuitry 16 (FIG. 1) may use the monitored/sensed charge, current, and/or voltage to infer the present tint/opacity level of tint layer 42, to monitor the real-time transition of tint layer 42 between charge levels and thus tint/opacity levels, to detect when tint layer 42 has reached a steady state after (e.g., a constant charge level and thus a constant tint/opacity level over time) transitioning between tint/opacity levels, and/or to detect when tint layer 42 deviates from a steady state (e.g., from a constant charge level) so that the drive current and/or voltage V can be adjusted/updated as necessary to return to or maintain the steady state (e.g., using a drive voltage or drive current feedback loop).

The monitor circuits in driver 80 may include current sensing (monitoring) circuitry such as current sensor (ISENSE) 266 and/or voltage sensing (monitoring) circuitry such as voltage sensor (VSENSE) 274. Current sensor 266 may be coupled to signal path 260 across resistor 264. Current sensor 266 may include an ammeter and/or an ADC that measures (senses) the current flowing through resistor 264 and thus across tint layer 42. If desired, current sensor 266 may be coupled to time counter circuitry such as time counter (TC) 267. Time counter 267 may count or measure the passage of time while the drive current is provided to tint layer 42. Since electrical current is equivalent to charge over time, time counter 267 and current sensor 266 may collectively form a charge sensor (e.g., a Coulomb counter) that senses the amount of charge present in tint layer 42. Alternatively, time counter 267 may be implemented on control circuitry 16 (FIG. 1).

Control circuitry 16 (FIG. 1) may use the current sensed by current sensor 266 and/or the charge sensed by the Coulomb counter to detect, monitor, measure, estimate, infer, or sense the present opacity/tint level of tint layer 42, a transition of tint layer 42 between first and second opacity/tint levels, to detect when tint layer 42 has reached a steady state (e.g., while tint layer 42 is in the voltage drive mode), to detect when tint layer 42 has deviated from the steady state, and/or to perform any other desired operations. Current sensor 266 may also be used to estimate the temperature of tint layer 42. The estimated temperature may be used to fine tune the drive signals provided to the tint layer to help ensure that the tint layer has a desired tint response given its present temperature.

Voltage sensor 274 may have a first input 272 and a second input 276. Voltage sensor 274 may include a voltmeter and/or an ADC that measures/senses the voltage across inputs 272 and 276. If desired, inputs 272 and 276 may be coupled to the same drive terminals 62 that are coupled to paths 260 and 262. As such, voltage sensor 274 may measure the voltage across tint layer 42 (e.g., between electrodes 76A and 76B) at the location of drive terminals 62 (e.g., the same location at which the tint layer is driven). Additionally or alternatively, inputs 272 and 276 may be coupled to dedicated voltage sensing terminals 270 on tint layer 42. Sensing terminals 270 are separated, offset, and/or remote from drive terminals 62 (e.g., voltage sensor 274 may be coupled to tint layer 42 at a location other than drive terminals 62). Voltage sensor 274 may measure the voltage across tint layer 42 (e.g., between electrodes 76A and 76B) at the location of sensing terminals 270 (e.g., at a location other than drive terminals 62). Sensing terminals 270 are sometimes also referred to herein as region of interest (ROI) sensing taps or remote sensing taps.

For example, as shown in FIG. 21, input 272 of voltage sensor 274 may be coupled to a first sensing terminal 270A on electrode 76A. Input 276 of voltage sensor 274 may be coupled to a second sensing terminal 270B on electrode 76B. If desired, voltage sensor 274 may switch between sensing the voltage across tint layer 42 at the location of drive terminals 62 and at the location of sensing terminals 270. As such, driver 80 may include a first switch 275A that switchably couples input 272 to one of the drive terminal 62 on electrode 76A and sensing terminal 270A at a given time. Similarly, driver 80 may include a second switch 275B that switchably couples input 276 to one of the drive terminal 62 on electrode 76B and sensing terminal 270B at a given time. Switches 275A and 275B may be placed in a first switch state to couple sensing terminals 270A and 270B to inputs 272 and 276, respectively, which configures voltage sensor 274 to measure the voltage across tint layer 42 at the location of sensing terminals 270. On the other hand, switches 275A and 275B may be placed in a second switch state to couple drive terminals 62 to inputs 272 and 276, which configures voltage sensor 274 to measure the voltage across tint layer 42 at the location of drive terminals 62. Alternatively, switches 275 may be omitted and voltage sensor 274 may be coupled to only sensing terminals 270 or may be coupled to only drive terminals 62.

Control circuitry 16 (FIG. 1) may use the voltage sensed by voltage sensor 274 to detect, monitor, measure, estimate, infer, or sense the present opacity/tint level of tint layer 42, a transition of tint layer 42 between first and second opacity/tint levels, to detect when tint layer 42 has reached a steady state (e.g., while tint layer 42 is in the voltage drive mode), to detect when tint layer 42 has deviated from the steady state, and/or to perform any other desired operations. If desired, the control circuitry may use the voltage sensed by voltage sensor 274 to detect, monitor, measure, estimate, infer, or sense the state of tint layer 42 while tint layer 42 is being driven by current driver 230 (e.g., while driver 80 is in the current drive mode) and may use the current and/or charge sensed by current sensor 266 to detect, monitor, measure, estimate, infer, or sense the state of tint layer 42 while tint layer 42 is being driven by voltage driver 232 (e.g., while driver 80 is in the voltage drive mode). The example of FIG. 21 illustrates how driver 80 may drive a single tint layer 42. If desired, similar circuitry may be used to drive both left and right tint layers 42 in system 10.

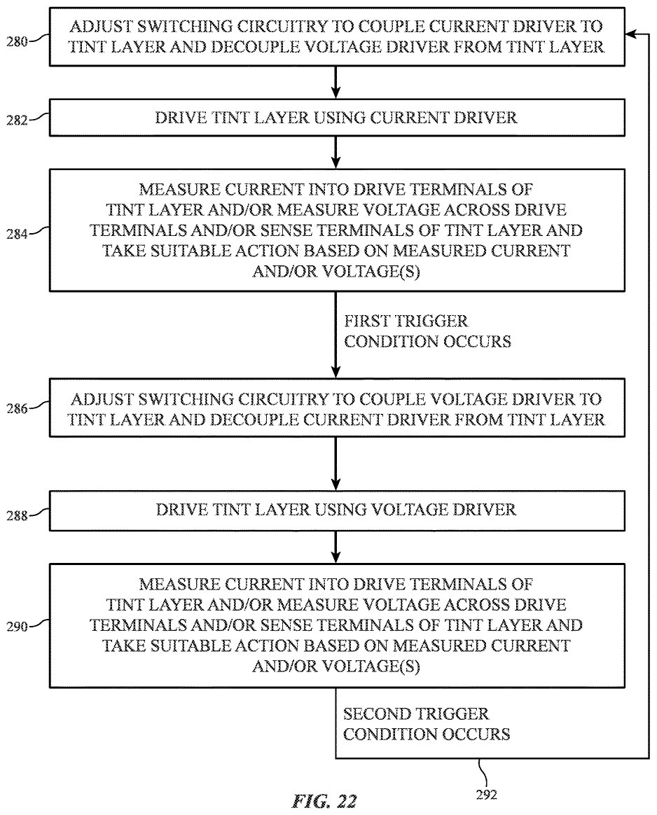

FIG. 22 is a flow chart of operations involved in driving tint layer 42 using current driver 230 and voltage driver 232. At operation 280, control circuitry 16 may adjust switching circuitry 234 (e.g., using switch control signal SWCTRL1) to communicatively couple current driver 230 to tint layer 42 (e.g., via circuit node 238 and H-bridge 258). Switching circuitry 234 may concurrently decouple voltage driver 232 from tint layer 42. This may serve to place driver 80 in the current drive mode.

At operation 282, current driver 230 may generate a drive current at one or more current magnitudes. Current driver 230 may provide the drive current to tint layer 42 via H-bridge 258. The drive current drives tint layer 42, causing charge to accumulate in tint layer 42 and transitioning tint layer 42 from a first tint/opacity level to a second tint/opacity level. If desired, current driver 230 may overdrive the drive current provided to tint layer 42 (e.g., using one or more overdrive pulses) and/or may underdrive the drive current provided to tint layer 42 (e.g., using one or more underdrive pulses).

At operation 284, one or more monitor circuits in driver 80 may gather measurements about or indicative of the state of tint layer 42. For example, current sensor 266 may measure (sense) the current flowing into the driver terminals 62 of tint layer 42, the Coulomb counter may measure (sense) the charge in tint layer 42, and/or voltage sensor 274 may measure (sense) the voltage across tint layer 42. The voltage measurements may include measurements of the voltage across drive terminals 62 and/or may include measurements of the voltage across sense terminals 270.

Control circuitry 16 (FIG. 1) may take any suitable action based on the current, charge, and/or voltage measurements while tint layer 42 is driven in the current drive mode. For example, control circuitry 16 may use the measurements to infer or estimate the present tint state (e.g., tint/opacity level, color response, etc.) of tint layer 42, to determine whether tint layer 42 is still in a transient state between a first tint/opacity level and a second tint/opacity level, to determine whether tint layer 42 has entered a steady state at a particular tint/opacity level, etc. In some implementations, control circuitry 16 may determine whether tint layer 42 has reached the steady state based on voltage measurements performed by voltage sensor 274 while driver 80 is in the current drive mode. If tint layer 42 has not yet reached the steady state (e.g., when tint layer 42 is still in a transient state), current driver 230 may adjust (e.g., increase or decrease) the magnitude of the drive current or may continue to use the same magnitude of drive current until the steady state is reached. Adjusting the drive current while still in the transient state may, for example, allow tint layer 42 to more quickly reach the steady state than when a single drive current magnitude is used, thereby minimizing the duration with which tint layer 42 is in the transient state.

Processing may proceed from operation 284 to operation 286 when a first trigger condition occurs (e.g., responsive to the first trigger condition). At operation 286, control circuitry 16 adjusts switching circuitry 234 (e.g., using switch control signal SWCTRL1) to communicatively couple voltage driver 232 to tint layer 42 (e.g., via circuit node 238 and H-44 bridge 258). Switching circuitry 234 may concurrently decouple current driver 230 from tint layer 42. This may serve to place driver 80 in the voltage drive mode.

The first trigger condition may be any desired trigger condition for the transition of driver 80 from the current drive mode to the voltage drive mode. The first trigger condition may, for example, be when tint layer 42 has entered or reached the steady state (e.g., as measured by voltage sensor 274), when tint layer 42 has exhibited a constant tint/opacity level for more than a threshold amount of time (e.g., as measured by voltage sensor 274, current sensor 266, and/or time counter 267), when the voltage across the drive terminals 62 and/or sense terminals 270 (e.g., as measured by voltage sensor 274) is equal to a predetermined value, when the current flowing through tint layer 42 (e.g., as measured by current sensor 266) is equal to a predetermined value, when the charge in tint layer 42 (e.g., as measured by current sensor 266 and time counter 267) is equal to a predetermined value, when a predetermined amount of time has elapsed while in the current drive mode and/or while providing the drive current at a particular magnitude, when control circuitry 16, software running on system 10, and/or a user input indicates, controls, or instructs system 10 to change the tint state (e.g., opacity/tint level, color response, transmission profile, etc.) of tint layer 42 and/or to change the drive mode of tint layer 42, and/or any other desired trigger condition.

At operation 288, voltage driver 232 may generate voltage V at one or more magnitudes. Voltage driver 232 may provide voltage V to tint layer 42 via H-bridge 258. Voltage V drives tint layer 42, causing charge to accumulate in tint layer 42. The charge may serve to transition tint layer 42 from a third tint/opacity level (e.g., the second tint/opacity level or a different tint/opacity level) to a fourth tint/opacity level (e.g., the first tint/opacity level or a different tint/opacity level) and/or may serve to maintain the second tint/opacity level as produced while in the current drive mode. If desired, voltage driver 232 may overdrive the drive current provided to tint layer 42 and/or may underdrive the drive current provided to tint layer 42 (e.g., as shown in FIG. 18).

At operation 290, one or more monitor circuits in driver 80 may gather measurements about or indicative of the state of tint layer 42. For example, current sensor 266 may measure (sense) the current flowing into the driver terminals 62 of tint layer 42, the Coulomb counter may measure (sense) the charge in tint layer 42, and/or voltage sensor 274 may measure (sense) the voltage across tint layer 42. The voltage measurements may include measurements of the voltage across drive terminals 62 and/or may include measurements of the voltage across sense terminals 270.

Control circuitry 16 (FIG. 1) may take any suitable action based on the current, charge, and/or voltage measurements while tint layer 42 is driven in the voltage drive mode. For example, control circuitry 16 may use the measurements to infer or estimate the present tint state (e.g., tint/opacity level, color response, etc.) of tint layer 42, to determine whether tint layer 42 is still in a transient state between a first tint/opacity level and a second tint/opacity level, to determine whether tint layer 42 has entered a steady state at a particular tint/opacity level, etc. In some implementations, control circuitry 16 may determine whether tint layer 42 has reached the steady state based on current and/or charge measurements performed by current sensor 266 and/or time counter 267 while driver 80 is in the voltage drive mode. If tint layer 42 has not yet reached the steady state (e.g., when tint layer 42 is still in a transient state), voltage driver 232 may adjust (e.g., increase or decrease) the magnitude of voltage V or may continue to use the same magnitude of voltage V until the steady state is reached, for example. Adjusting the magnitude of voltage V while still in the transient state may, for example, allow tint layer 42 to more quickly reach the steady state than when a single voltage magnitude is used, thereby minimizing the duration with which tint layer 42 is in the transient state.

Processing may loop back to operation 280 via path 292 when a second trigger condition occurs (e.g., responsive to the second trigger condition). The second trigger condition may be any desired trigger condition for the transition of driver 80 from the voltage drive mode to the current drive mode. The second trigger condition may, for example, be when tint layer 42 has entered or reached the steady state (e.g., as measured by current sensor 266 and optionally time counter 267), when tint layer 42 has exhibited a constant tint/opacity level for more than a threshold amount of time (e.g., as measured by voltage sensor 274, current sensor 266, and/or time counter 267), when the voltage across the drive terminals 62 and/or sense terminals 270 (e.g., as measured by voltage sensor 274) is equal to a predetermined value, when the current flowing through tint layer 42 (e.g., as measured by current sensor 266) is equal to a predetermined value, when the charge in tint layer 42 (e.g., as measured by current sensor 266 and time counter 267) is equal to a predetermined value, when a predetermined amount of time has elapsed while in the voltage drive mode and/or while providing voltage V at a particular magnitude, when control circuitry 16, software running on system 10, and/or a user input indicates, controls, or instructs system 10 to change the tint state (e.g., opacity/tint level, color response, transmission profile, etc.) of tint layer 42, and/or any other desired trigger condition.

The timing diagram of FIG. 18 illustrates an example in which driver 80 overdrives the voltage V provided to tint layer 42. Additionally or alternatively, driver 80 may overdrive a drive current provided to tint layer 42. This may, for example, serve to accelerate the transition of tint layer 42 between tint/opacity levels.

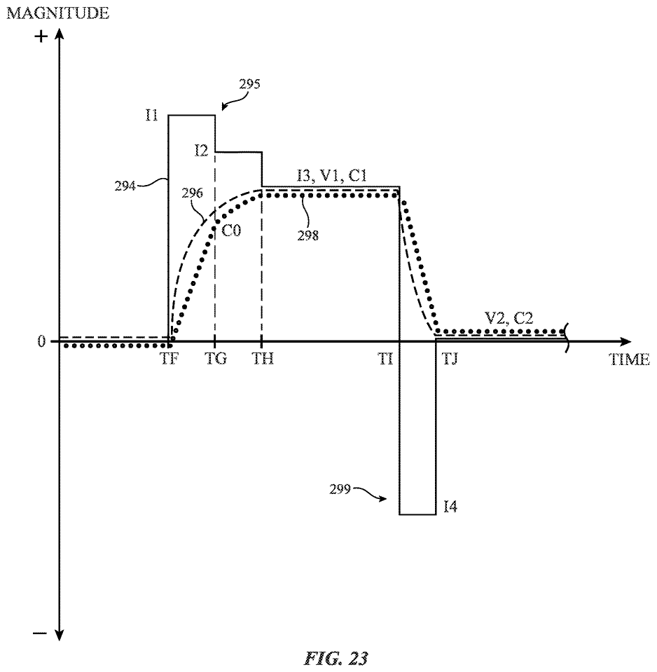

FIG. 23 shows an example of how driver 80 may overdrive a drive current provided to tint layer 42. As shown in FIG. 23, curve 294 plots the waveform of a drive current I through tint layer 42 as a function of time (e.g., as generated by current driver 230 of FIG. 21 or other current driver circuitry in driver 80). Dotted curve 298 plots the charge (e.g., in Coulombs C) of tint layer 42 as a function of time in response to the corresponding drive current I. Dashed curve 296 plots the corresponding tint response of tint layer 42 as a function of time.

As shown by curves 294 and 296, tint layer 42 may be in a first tint state (e.g., a clear state) while drive current I has a magnitude of zero prior to time TF. At time TF, driver 80 may pulse drive current I. When drive current I has the magnitude I3, sufficient charge may accumulate in tint layer 42 to transition tint layer 42 to a second tint state (e.g., an opaque state). To accelerate the transition (e.g., darkening) of tint layer 42 from the first tint state to the second tint state, rather than pulsing drive current I to magnitude I3, driver 80 may overdrive tint layer 42 by pulsing drive current I to a magnitude I1 greater than magnitude I3 (e.g., as shown by overdrive current pulse 295). As shown by curve 298, overdrive current pulse 295 may cause charge to accumulate at a first rate from a charge of zero at time TF to a charge C0 at time TG.

If desired, at time TG, driver 80 may reduce the magnitude of drive current I to magnitude 12 (e.g., an overdrive magnitude less than magnitude I1). This may cause charge to accumulate at a second rate (e.g., lower than the first rate) from a charge of C0 at time TG to a charge of C1 at time TH. As shown by curves 298 and 296, tint layer 42 may be in the second tint state (e.g., an opaque state) when tint layer 42 has charge C1. Once the charge of tint layer 42 has reached charge C1 (e.g., at time TH), driver 80 may reduce the magnitude of drive current I to magnitude I3 to continue to hold current C1 in tint layer 42, maintaining tint layer 42 in the second tint state.

The example of FIG. 23 is illustrative and non-limiting. If desired, driver 80 may overdrive the drive current I to a single magnitude (e.g., magnitude I1, magnitude I2, or another magnitude greater than magnitude I3), may overdrive the drive current I to more than two magnitudes, and/or may overdrive the drive current I using any desired number of one or more overdrive pulses (e.g., magnitudes greater than magnitude I1, less than magnitude I2, less than magnitude I3, between magnitudes I1 and I2, and/or between magnitudes I2 and I3).

At time TI, driver 80 may begin to transition tint layer 42 from the second tint state back to the first tint state. To accelerate the transition of tint layer 42 from the second tint state back to the first tint state, rather than returning drive current I to a magnitude of zero at time TI, driver 80 may underdrive tint layer 42 by pulsing drive current I to a negative magnitude 14 that is less than zero (e.g., as shown by underdrive current pulse 299). At time TJ, driver 80 may increase drive current I back to a magnitude of zero (e.g., ending underdrive pulse 299). When drive current I is at a magnitude of zero, a corresponding charge C2 is present in tint layer 42. Tint layer 42 is in the first tint state (e.g., a transparent or clear state) while tint layer 42 has charge C2.

The example of FIG. 23 is illustrative and non-limiting. If desired, driver 80 may underdrive the drive current I to a single magnitude (e.g., magnitude I4), may underdrive the drive current I to more than two magnitudes, and/or may underdrive the drive current I using any desired number of one or more underdrive pulses (e.g., magnitudes greater than magnitude 14 and less than zero, magnitudes greater than zero and less than magnitude I3, and/or magnitudes less than magnitude I4).

As shown by curve 296, tint layer 42 is in a steady state of the first tint state prior to time TF and after time TJ and is in a steady state of the second tint state between times TH and TI. On the other hand, tint layer 42 is in a transient state between the first and second tint states between times TF and TH and between times TI and TJ. Overdriving and/or under-driving the drive current I may serve to minimize the duration of the transient states.

Voltage sensor 274 (FIG. 21) may sense or measure the voltage V across tint layer 42 over time, current sensor 266 may measure the current in tint layer 42 over time, and/or a Coulomb counter (e.g., current sensor 266 and time counter 267) may measure the charge C in tint layer 42 over time to determine, identify, sense, infer, or detect when tint layer 42 has entered a steady state of the first and/or second tint states (e.g., while processing operations 284 and/or 290 of FIG. 22). If desired, driver 80 may switch from the current drive mode to the voltage drive mode (or vice versa) in response to detecting that tint layer 42 has entered the steady state.

For example, voltage sensor 274 may measure the voltage across drive terminals 62 and/or sense terminals 270 while driver 80 is in the current drive mode and drives tint layer 42 using drive current I. At time TH, voltage sensor 274 measures a voltage across tint layer 42 that is indicative of tint layer 42 being in the steady opaque (dark) state. In response to this measurement (e.g., the first trigger condition of FIG. 22), driver 80 may transition from the current drive mode to the voltage drive mode after time TH. As such, after time TH, voltage driver 232 may drive tint layer 42 with a voltage V having magnitude V1 rather than using a drive current. Magnitude V1 may, for example, be a voltage that causes tint layer 42 to continue to have charge C1, configuring tint layer 42 to remain in the steady opaque state until time TI. Additionally or alternatively, voltage driver 232 may drive tint layer 42 with a voltage having magnitude V2 when tint layer 42 is in the steady transparent state after time TJ. Magnitude V2 may, for example, be a voltage that causes tint layer 42 to continue to have charge C2, configuring tint layer 42 to remain in the steady transparent state after time TJ.

In general, either current driver 230 or voltage driver 232 may be used to drive tint layer 42 when or responsive to tint layer 42 entering a steady state. Driving tint layer 42 using drive current I may, for example, accelerate the transition of tint layer 42 between steady states relative to driving tint layer 42 using voltage V. On the other hand, driving tint layer 42 using voltage V may provide more stability and control to tint layer 42 and driver 80, may be simpler to implement, and/or may consume less power than driving tint layer 42 using drive voltage I. As such, switching between current drive and voltage drive modes over time can serve to optimize or balance the transition time of tint layer 42 with control, stability, and/or power consumption.

In the examples of FIGS. 3-16 and 21, tint layer 42 is illustrated as being driven at a single location by a single pair of drive terminals 62 for the sake of clarity. This is illustrative and non-limiting. If desired, tint layer 42 may be driven by multiple pairs of drive terminals 62 that are disposed at different points along the periphery of electrochromic gel 78.

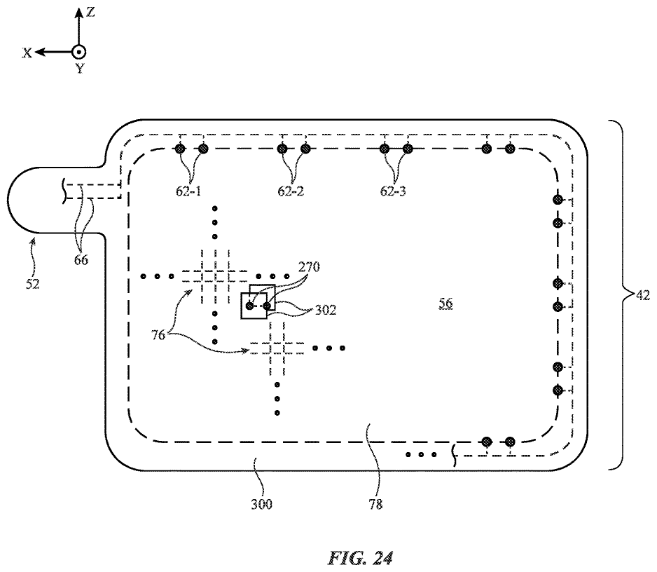

FIG. 24 is a front view showing one example of how tint layer 42 may include multiple pairs of drive terminals 62 at different points along the periphery of electrochromic gel 78. As shown in FIG. 24, tint layer 42 may have a peripheral region 300 laterally surrounding its active area 56 formed from electrochromic gel 78. Tint layer 42 may also include electrodes 76 (e.g., ITO traces) within active area 56 (e.g., on either side of electrochromic gel 78 as shown in FIGS. 4-7). Control lines 66 may pass from extension 52 into peripheral region 300 and may extend around active area 56 within peripheral region 300.

Control lines 66 may be coupled to electrodes 76 at multiple pairs of drive terminals 62. Each pair of drive terminals 62 may be disposed at a different respective location along the lateral periphery of active area 56. For example, control lines 66 may be coupled to a first pair of drive terminals 62-1 at a first location on the lateral periphery of electrodes 76, a second pair of drive terminals 62-2 at a second location on the lateral periphery of electrodes 76, a third pair of drive terminals 62-3 at a third location on the lateral periphery of electrodes 76, etc. Each pair of drive terminals 62 includes a first drive terminal coupled to the first electrode 76 of tint layer 42 (e.g., electrode 76A of FIGS. 4-7 and 21) and a second drive terminal coupled to the second electrode 76 of tint layer 42 (e.g., electrode 76B of FIGS. 4-7 and 21). Each pair of drive terminals 62 is sometimes also referred to herein as a drive tap of tint layer 42.

In general, the resistance of the ITO traces forming electrodes 76 and/or the electrical interfaces of tint layer 42 cause the voltage between electrodes 76 and/or the charge accumulated between electrodes 76 to decrease as the lateral distance from drive terminals 62 increases. When a single pair of drive terminals 62 is used to drive tint layer 42, this can cause the optical state/characteristic (e.g., tint/opacity level, color response, etc.) of electrochromic gel 78 to undesirably vary at farther distances from that pair of drive terminals. By driving tint layer 42 at multiple locations along the lateral periphery of active area 56 as shown in FIG. 24, a more consistent and uniform voltage drop and thus accumulated charge is produced between electrodes 76 around the entire lateral periphery of active area 56, thereby allowing tint layer 42 to exhibit a more uniform tint response across its viewable area.

FIG. 24 also shows how tint layer 42 may include sense terminals 270 that are separate from drive terminals 62 and that are coupled to voltage sensor 274 (FIG. 21) for sensing the voltage across electrochromic gel 78. As shown in FIG. 24, tint layer 78 may include a pair of conductive contacts 302 (e.g., ITO traces or contact pads) that are co-planar with and/or laterally surrounded by the electrodes 76 in tint layer 42 on either side of electrochromic gel 78 (e.g., electrochromic gel 78 may be vertically interposed or sandwiched between contacts 302 along the Y-axis and contacts 302 may be integrated into or surrounded by the resistive mesh formed from the ITO traces of electrodes 76).

Contacts 302 may overlap active area 56 and may be offset from the lateral periphery of electrodes 76. Contacts 302 may, for example, be disposed at, adjacent, or near the lateral center of tint layer 42. As another example, contacts 302 and thus sense terminals 270 may be disposed at a location on tint layer 42 that overlaps the output coupler 38 on the underlying waveguide 32 (FIG. 2) or that overlaps a portion of the underlying waveguide 32 that is adjacent to output coupler 32. In general, electrodes 76 are effectively formed from a two-dimensional mesh of resistances (e.g., as produced by the ITO traces of electrodes 76). This causes the voltage across electrochromic gel 78 at the portion of tint layer 42 overlapping output coupler 38 (FIG. 2) to be different than the voltage across electrochromic gel 78 at the lateral periphery of electrodes 76.

As such, the opacity of electrochromic gel 78 may be slightly different at the lateral periphery of electrodes 76 (e.g., at drive terminals 62) than at the portion of tint layer 42 overlapping the output coupler 38 on the underlying waveguide 32. By disposing contacts 302 away from the periphery of active area 56 in this way, voltage sensor 274 may more accurately measure the tint state of tint layer 42 as viewed by a user through output coupler 38 (FIG. 2) than when voltage sensor 274 measures voltage between drive terminals 62. This may, for example, allow the control circuitry to more accurately detect, using voltage sensor 274, when tint layer 42 has reached a desired steady state. In other words, tint layer 42 may be effectively modeled as a delay network and sensing the voltage at a location that is farthest away from drive terminals 62 (e.g., at contacts 302) may best capture whether the steady state has been reached across tint layer 42, including at the location that transmits world light to eye box 24 through the overlapping output coupler 38 (FIG. 2).

In general, there may any desired number of pairs of drive terminals 62 around the lateral periphery of electrodes 76. The greater the number of pairs of drive terminals, the more uniform the tint response of tint layer 42. If desired, to further increase the tint uniformity of tint layer 42, tint layer 42 may be driven using elongated continuous drive contacts that extend around the lateral periphery of electrodes 76.

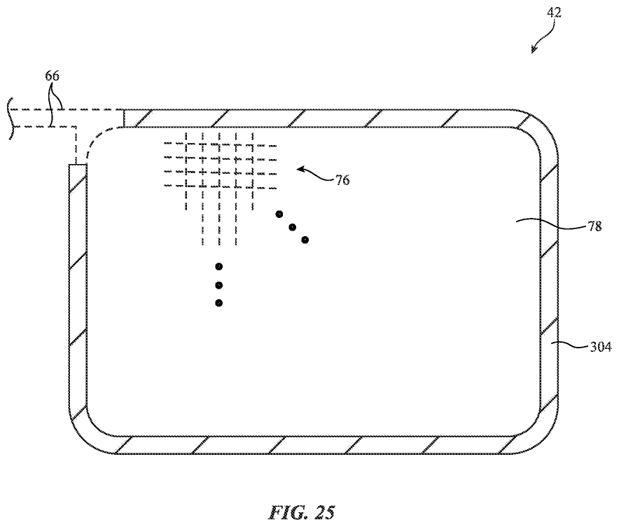

FIG. 25 is a front view showing one example of how tint layer 42 may include elongated drive contacts that extend around electrodes 76 for driving tint layer 42 continuously along its lateral periphery. As shown in FIG. 25, tint layer 42 may include a pair of drive contacts 304 (e.g., bars of ITO or other conductive and optionally transparent materials). Drive contacts 304 are coupled to control lines 66 and extend continuously around some or all of the lateral periphery of electrodes 76. Drive contacts 304 may be continuously coupled to the lateral periphery of electrodes 76.

Drive contacts 304 include a first drive contact coupled to the first electrode 76 of tint layer 42 (e.g., electrode 76A of FIGS. 4-7 and 21) and a second drive contact coupled to the second electrode 76 of tint layer 42 (e.g., electrode 76B of FIGS. 4-7 and 21). Drive contacts 304 may drive electrochromic gel 78 using a voltage V and/or a drive current that is continuously distributed along the lateral periphery of electrodes 76, thereby maximizing the tint uniformity of tint layer 42.

If desired, driver 80 may include a buck converter coupled in series with an LDO regulator for driving both electrodes of tint layer 42. In implementations where driver 80 includes a buck converter coupled in series with an LDO regulator, driver 80 may switch between driving tint layer 42 using the buck converter and driving tint layer 42 using the LDO regulator.

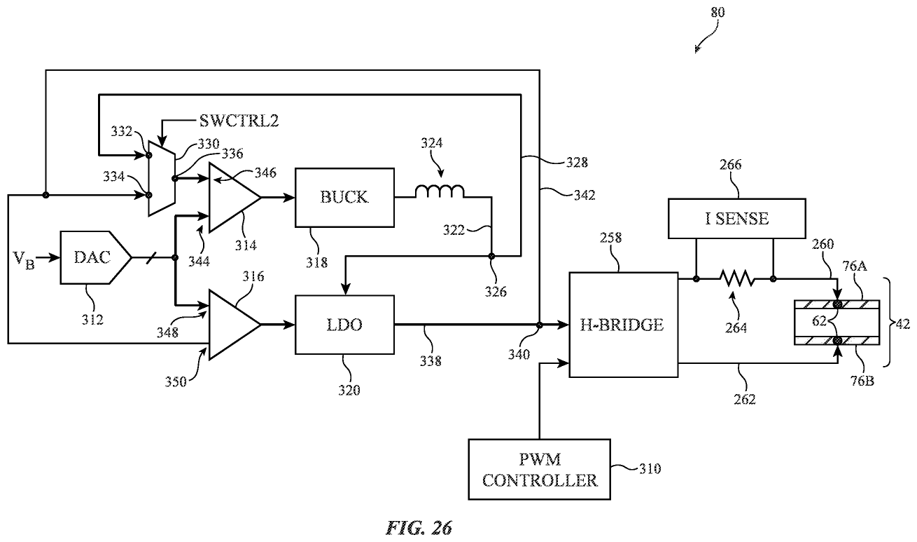

FIG. 26 is a circuit diagram showing one example of how driver 80 may include a buck converter coupled in series with an LDO regulator for driving tint layer 42. As shown in FIG. 26, driver 80 may include a buck converter such as buck converter 318 (e.g., a tunable buck converter) and an LDO regulator such as LDO regulator 320. LDO regulator 320 may be coupled in series between the output of buck converter 318 and a first input of H-bridge 258. As such, the output of buck converter 318 may be coupled to a first input of LDO regulator 320 over path 322. The output of LDO regulator 320 may be coupled to the first input of H-bridge 258 over path 338. If desired, H-bridge 258 may have a second input coupled to the output of PWM controller 310. The outputs of H-bridge 358 are coupled to drive terminals 62 on electrodes 76A and 76B of tint layer 42 over paths 260 and 262, respectively.

Current sensor 266 may be coupled across resistor 264 on path 260. Voltage sensor 274 (FIG. 21), sense terminals 270 (FIGS. 21 and 24), switches 275 (FIG. 21), and time counter 267 (FIG. 21) have been omitted from FIG. 26 for the sake of clarity. The current sensor and voltage sensor may be used to provide feedback on the present state of tint layer 42, to adjust the magnitude of the drive voltage provided to tint layer 42, and/or to help monitor and maintain tint layer 42 in a steady state (e.g., as described above in connection with FIGS. 21-23). If desired, paths 260 and 262 may be coupled to multiple different pairs of drive terminals 62 on tint layer 42 (e.g., as shown in FIG. 24) or may be continuously coupled to electrodes 76 using contacts 304 (FIG. 25). Buck converter 318 and LDO regulator 320 may drive tint layer 42 using voltage V (e.g., in a voltage drive mode). If desired, driver 80 of FIG. 26 may also include a current driver 230 (FIG. 21) for driving tint layer 24 in a current drive mode.

As shown in FIG. 26, driver 80 may include switching circuitry such as switch 330 (e.g., an adjustable multiplexer), buffer circuitry such as buffers 314 and 316, and a DAC such as DAC 312. The input of DAC 312 may receive reference voltage VB or another reference voltage. Switch 330 may have an output terminal (port) 336, a first input terminal (port) 332, and a second input terminal (port) 334. Buffer 314 has a first input 346 coupled to the output terminal 336 of switch 330 and a second input 344 coupled to the digital output of DAC 312. The output of buffer 314 may be coupled to the input of buck converter 318.

The output of buck converter 318 may be communicatively coupled to its input (e.g., through switch 330 and buffer 314). Driver 80 may include a feedback path 328 that couples a circuit node 326 on path 322 to input terminal 332 of switch 330. Buffer 316 has a first input 348 coupled to the digital output of DAC 312 and has a second input 350. The output of buffer 316 is coupled to a second input of LDO regulator 320. The output of LDO regulator 320 may be communicatively coupled its second input (e.g., through buffer 316) and may be communicatively coupled to the input of buck converter 318 (e.g., through switch 330 and buffer 314). Driver 80 may include a feedback path 342 that couples a circuit node 340 on path 338 to input terminal 334 of switch 330 and to input 350 of buffer 316. In this way, buck converter 318 may be coupled in series between buffer 314 or the output of DAC 312 and LDO regulator 320. Similarly, LDO regulator 320 may be coupled in series between buck converter 318 and the input of H-bridge 258.

Switch 330 may be switchable between at least first and second switch states. Switch 330 may receive switch control signal SWCTRL2 (e.g., from control circuitry 16 of FIG. 1) that places switch 330 in a selected switch state at a given time. In the first switch state, switch 330 couples input terminal 332 to output terminal 336 (e.g., forming a short circuit impedance between terminals 332 and 336 while concurrently decoupling input terminal 334 from output terminal 336 or forming an open circuit impedance between terminals 334 and 336). In the second switch state, switch 330 couples input terminal 334 to output terminal 336 (e.g., forming a short circuit impedance between terminals 334 and 336 while concurrently decoupling input terminal 332 from output terminal 336 or forming an open circuit impedance between terminals 332 and 336).

Driver 80 may be operable in a first operating mode (state) in which buck converter 318 drives tint layer 42. The first operating mode is sometimes also referred to herein as a buck drive mode or state. Driver 80 may also be operable in a second operating mode (state) in which LDO regulator 320 drives tint layer 42. The second operating mode or state is sometimes also referred to herein as an LDO drive mode or state. Driver 80 may be switchable between the buck drive mode and the LDO drive mode over time.

In the buck drive mode, switch 330 is in the first switch state, coupling input terminal 332 to output terminal 336. DAC 312 provides a digital signal to the input of buck converter 318 through buffer 314 (e.g., based on reference voltage V_{B}). Buck converter 318 may also receive reference voltage V_{B} and may be programmed (e.g., using control signal CTRL of FIGS. 8-16) to output voltage V at a desired magnitude for driving tint layer 42. LDO regulator 320 is placed in a switch mode while driver 80 is in the buck drive mode. The drive signal is passed from buck converter 318 over path 322, through LDO regulator 320 while in switch mode, over path 338, and to H-bridge 258, which drives electrodes 76A and 76B using the drive signal (e.g., voltage V). The drive signal is also fed back to the input of buck converter 318 over feedback path 342 and through switch 330 and buffer 314. If desired, PWM controller 310 may provide a PWM control signal to H-bridge 258 to fine-tune and/or dither the step size and/or accuracy of the drive voltage. Operating driver 80 in buck drive mode may configure driver 80 to exhibit greater power efficiency than when operating in the LDO drive mode, for example.

On the other hand, in the LDO drive mode, switch 330 is placed in the second switch state, coupling input terminal 334 to output terminal 336. DAC 312 provides a digital signal to the input of LDO regulator 320 through buffer 316 (e.g., based on reference voltage V_{B}). The digital signal may also be passed to the input of buck converter 318 via buffer 314. LDO regulator 320 may output voltage V at a desired magnitude for driving tint layer 42 based on the digital signal from DAC 312. Buck converter 318 may help to ensure that the LDO supply tracks its output (e.g., the output of buck converter 318 may be fed back to its input over feedback path 328, from input terminal 332 to output terminal 336 of switch 330 while in the second switch state, and through buffer 314). At the same time, LDO regulator 320 passes the drive signal (e.g., voltage V) to H-bridge 258, which drives electrodes 76A and 76B using the drive signal. The drive signal is also fed back to the input of LDO regulator 320 over feedback path 342 and through buffer 316. If desired, PWM controller 310 may provide a PWM control signal to H-bridge 258 to fine-tune and/or dither the step size and/or accuracy of the drive voltage.

Operating driver 80 in LDO drive mode may configure driver 80 to exhibit greater output accuracy and may allow driver 80 to produce lower voltage magnitudes (e.g., down to around 0.4-0V) than when operating in the buck drive mode. Driver 80 may, for example, drive tint layer 42 at higher magnitudes of voltage V (e.g., 0.4-1.2V) in the buck drive mode than in the LDO drive mode. By switching driver 80 between the buck drive and LDO drive modes over time, driver 80 may drive tint layer 42 while optimizing both drive voltage accuracy and power efficiency, depending on its current operating conditions and the desired tint state of tint layer 42. The example of FIG. 26 illustrates how driver 80 may drive a single tint layer 42. If desired, similar circuitry may be used to drive both left and right tint layers 42 in system 10.

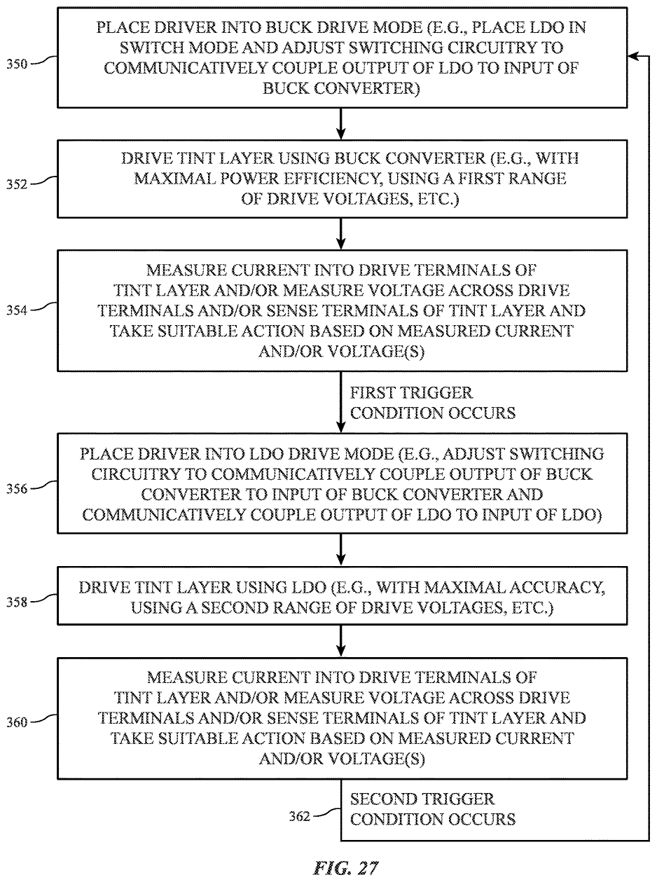

FIG. 27 is a flow chart of operations involved in driving tint layer 42 using buck converter 318 and LDO regulator 320 of FIG. 26. At operation 350, control circuitry 16 may place switch 330 in its first switch state (e.g., using switch control signal SWCTRL2), which places driver 80 in the buck drive mode. This also communicatively couples the output of LDO regulator 320 to the input of buck converter 318 via feedback path 342, switch 330, and buffer 314). The control circuitry may also provide a control signal to LDO regulator 320 to place the LDO regulator into its switch mode if desired.

At operation 352, buck converter 318 may generate voltage V at one or more magnitudes. Buck converter 318 may provide voltage V to tint layer 42 via path 322, LDO regulator 320 (while in switch mode), path 338, and H-bridge 258. Voltage V drives tint layer 42, causing charge to accumulate in tint layer 42 and transitioning tint layer 42 from a first tint/opacity level to a second tint/opacity level. If desired, driver 80 may overdrive the drive voltage provided to tint layer 42 (e.g., using one or more overdrive pulses) and/or may underdrive the drive voltage provided to tint layer 42 (e.g., using one or more underdrive pulses). Voltage V may also be provided with PWM (e.g., using PWM controller 310) to fine tune and/or dither the voltage. Voltage V may exhibit a first range of magnitudes driven in the buck drive mode (e.g., around 0.4-1.2V) and may exhibit greater power efficiency than when driven in the LDO drive mode, for example.

At operation 354, current sensor 266 and/or voltage sensor 274 (FIG. 21) may measure the current, voltage, and/or charge of tint layer 42 while driven in the buck drive mode (e.g., as described above in connection with operation 284 of FIG. 22). Control circuitry 16 (FIG. 1) may take any suitable action based on the current, charge, and/or voltage measurements while tint layer 42 is driven in the buck drive mode. For example, control circuitry 16 may use the measurements to infer or estimate the present tint state (e.g., tint/opacity level, color response, etc.) of tint layer 42, to determine whether tint layer 42 is still in a transient state between tint/opacity levels, to determine whether tint layer 42 has entered a steady state at a particular tint/opacity level, etc. If tint layer 42 has not yet reached the steady state (e.g., when tint layer 42 is still in a transient state), driver 80 may adjust (e.g., increase or decrease) the magnitude of voltage V or may continue to use the same voltage magnitude until the steady state is reached, for example.

Processing may proceed from operation 354 to operation 356 when a first trigger condition occurs. At operation 356, control circuitry 16 adjusts switch 330 to place driver 80 into LDO drive mode. Switch 330 is in its second switch state while driver 80 is in the LDO drive mode, communicatively coupling the output of buck converter 318 to its input.

The first trigger condition may be any desired trigger condition for the transition of driver 80 from the buck drive mode to the LDO drive mode. The first trigger condition may, for example, be when greater output accuracy is desired for driving tint layer 42 than is achievable in the buck drive mode, when the drive voltage needs to exhibit a magnitude within a second range of magnitudes that is lower than the first range of magnitudes (e.g., 0.4-0V) for tint layer 42 to exhibit a desired optical response, when tint layer 42 has entered or reached a steady state, when the current, voltage, and/or charge sensed at tint layer 42 is equal to a predetermined value, when a predetermined amount of time has elapsed while in the buck drive mode and/or while providing the drive voltage at a particular magnitude, when control circuitry 16, software running on system 10, and/or a user input indicates, controls, or instructs system 10 to change the tint state (e.g., opacity/tint level, color response, transmission profile, etc.) of tint layer 42, when control circuitry 16, software running on system 10, and/or a user input indicates, controls, or instructs system 10 to change from the buck drive mode to the LDO drive mode, and/or any other desired trigger condition.

At operation 358, LDO regulator 320 may generate voltage V at one or more magnitudes. LDO regulator 320 may provide voltage V to tint layer 42 via path 338 and H-bridge 258. Voltage V drives tint layer 42, causing charge to accumulate in tint layer 42 to transition tint layer 42 from the second tint/opacity level to a third tint/opacity level (or between any other desired tint/opacity levels). If desired, driver 80 may overdrive the drive voltage provided to tint layer 42 (e.g., using one or more overdrive pulses) and/or may underdrive the drive voltage provided to tint layer 42 (e.g., using one or more underdrive pulses). Voltage V may also be provided with PWM (e.g., using PWM controller 310) to fine tune and/or dither the voltage. Voltage V may exhibit a second range of magnitudes driven in the LDO drive mode (e.g., around 0.4-1.2V) and may exhibit greater output accuracy than when driven in the buck drive mode, for example.

At operation 360, current sensor 266 and/or voltage sensor 274 (FIG. 21) may measure the current, voltage, and/or charge of tint layer 42 while driven in the LDO drive mode (e.g., as described above in connection with operation 284 of FIG. 22). Control circuitry 16 (FIG. 1) may take any suitable action based on the current, charge, and/or voltage measurements while tint layer 42 is driven in the LDO drive mode. For example, control circuitry 16 may use the measurements to infer or estimate the present tint state (e.g., tint/opacity level, color response, etc.) of tint layer 42, to determine whether tint layer 42 is still in a transient state between tint/opacity levels, to determine whether tint layer 42 has entered a steady state at a particular tint/opacity level, etc. If tint layer 42 has not yet reached the steady state (e.g., when tint layer 42 is still in a transient state), driver 80 may adjust (e.g., increase or decrease) the magnitude of voltage V or may continue to use the same voltage magnitude until the steady state is reached, for example.

Processing may loop back to operation 350 via path 362 when a second trigger condition occurs, returning to the buck drive mode. The second trigger condition may be any desired trigger condition for the transition of driver 80 from the LDO drive mode to the buck drive mode. The second trigger condition may, for example, be when greater power efficiency is desired for driving tint layer 42 than is achievable in the LDO drive mode, when the drive voltage needs to exhibit a magnitude within the first range of magnitudes (e.g., higher than supported by the LDO drive mode) for tint layer 42 to exhibit a desired optical state (e.g., opacity, tint level, color response, etc.), when tint layer 42 has entered or reached a steady state, when the current, voltage, and/or charge sensed at tint layer 42 is equal to a predetermined value, when a predetermined amount of time has elapsed while in the LDO drive mode and/or while providing the drive voltage at a particular magnitude, when control circuitry 16, software running on system 10, and/or a user input indicates, controls, or instructs system 10 to change the tint state (e.g., opacity/tint level, color response, transmission profile, etc.) of tint layer 42, when control circuitry 16, software running on system 10, and/or a user input indicates, controls, or instructs system 10 to change from the LDO drive mode to the buck drive mode, and/or any other desired trigger condition.

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent.”

As described above, one aspect of the present technology is the gathering and use of information such as information from input-output devices. The present disclosure contemplates that in some instances, data may be gathered that includes personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, username, password, biometric information, or any other identifying or personal information.

The present disclosure recognizes that the use of such personal information, in the present technology, can be used to the benefit of users. For example, the personal information data can be used to deliver targeted content that is of greater interest to the user. Accordingly, use of such personal information data enables users to have control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the United States, collection of or access to certain health data may be governed by federal and/or state laws, such as the Health Insurance Portability and Accountability Act (HIPAA), whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to provide certain types of user data. In yet another example, users can select to limit the length of time user-specific data is maintained. In addition to providing “opt in” and “opt out” options, the present disclosure contemplates providing notifications relating to the access or use of personal information. For instance, a user may be notified upon downloading an application (“app”) that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of information that may include personal information data to implement one or more various disclosed embodiments, the present disclosure also contemplates that the various embodiments can also be implemented without the need for accessing personal information data. That is, the various embodiments of the present technology are not rendered inoperable due to the lack of all or a portion of such personal information data.

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Computer-generated reality: in contrast, a computer-generated reality (CGR) environment refers to a wholly or partially simulated environment that people sense and/or interact with via an electronic system. In CGR, a subset of a person's physical motions, or representations thereof, are tracked, and, in response, one or more characteristics of one or more virtual objects simulated in the CGR environment are adjusted in a manner that comports with at least one law of physics. For example, a CGR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a CGR environment may be made in response to representations of physical motions (e.g., vocal commands). A person may sense and/or interact with a CGR object using any one of their senses, including sight, sound, touch, taste, and smell. For example, a person may sense and/or interact with audio objects that create 3D or spatial audio environment that provides the perception of point audio sources in 3D space. In another example, audio objects may enable audio transparency, which selectively incorporates ambient sounds from the physical environment with or without computer-generated audio. In some CGR environments, a person may sense and/or interact only with audio objects. Examples of CGR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationery with respect to the physical ground. Examples of mixed realities include augmented reality and augmented virtuality. Augmented reality: an augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof. Augmented virtuality: an augmented virtuality (AV) environment refers to a simulated environment in which a virtual or computer generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

Hardware: there are many different types of electronic systems that enable a person to sense and/or interact with various CGR environments. Examples include head mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mounted system may have one or more speaker(s) and an integrated opaque display. Alternatively, a head mounted system may be configured to accept an external opaque display (e.g., a smartphone). The head mounted system may incorporate one or more imaging sensors to capture images or video of the physical environment, and/or one or more microphones to capture audio of the physical environment. Rather than an opaque display, a head mounted system may have a transparent or translucent display. The transparent or translucent display may have a medium through which light representative of images is directed to a person's eyes. The display may utilize digital light projection, OLEDs, LEDs, μLEDs, liquid crystal on silicon, laser scanning light sources, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

Further aspects of the disclosure are presented in the examples listed below, which may be combined together in any desired order or manner and which may be combined with any of the other embodiments or examples described herein.

In an example, an electronic device is provided that includes a waveguide configured to propagate first light; an optical coupler on the waveguide and configured to couple the first light out of the waveguide; a tint layer overlapping the optical coupler and configured to pass second light to the waveguide, wherein the tint layer includes a first substrate, a first electrode layered onto the first substrate, a second substrate, a second electrode layered onto the second substrate, and an electrochromic material interposed between the first and second electrodes; a driver configured to generate a voltage across the first and second electrodes; and a flexible printed circuit having a first lateral surface, a second lateral surface opposite the first lateral surface, a first conductive trace on the first lateral surface that couples the driver to the first electrode, and a second conductive trace on the second lateral surface that couples the driver to the second electrode.

In another example, a portion of the flexible printed circuit having the first and second conductive traces is interposed between the first substrate and the second substrate.

In another example, the first conductive trace is adhered to the first electrode and the second conductive trace is adhered to the second electrode.

In another example, the first conductive trace is adhered to the first electrode using conductive epoxy, anisotropic conductive film (ACF), conductive adhesive, pressure sensitive adhesive, or silver paste.

In an example, an electronic device is provided that includes a waveguide configured to propagate first light; an optical coupler on the waveguide and configured to couple the first light out of the waveguide; a tint layer overlapping the optical coupler and configured to pass second light to the waveguide, the tint layer including a first substrate, a first electrode layered onto the first substrate, a second substrate, a second electrode layered onto the second substrate, and an electrochromic material interposed between the first and second electrodes; a driver configured to generate a voltage across the first and second electrodes; a first flexible printed circuit tail having a first conductive trace that couples the driver to the first electrode; and a second flexible printed circuit tail having a second conductive trace that couples the driver to the second electrode.

In another example, the first flexible printed circuit tail and the second flexible printed circuit tail are interposed between the first substrate and the second substrate.

In another example, the first flexible printed circuit tail is laterally offset with respect to the second flexible printed circuit tail.

In another example, the first flexible printed circuit tail overlaps the second flexible printed circuit tail.

In another example, the tint layer further includes an encapsulant between the first and second substrates, the first and second flexible printed circuit tails being embedded within the encapsulant.

In another example, the electronic device further includes a flexible printed circuit having the first and second flexible printed circuit tails.

In another example, the electronic device further includes a first flexible printed circuit having the first flexible printed circuit tail; and a second flexible printed circuit having the second flexible printed circuit tail.

In another example, the first conductive trace is adhered to the first electrode using conductive epoxy, anisotropic conductive film (ACF), conductive adhesive, pressure sensitive adhesive, or silver paste.

In another example, the electronic device further includes a first conductive wire that couples the driver to the first conductive trace; and a second conductive wire that couples the driver to the second conductive trace.

In an example, an electronic device is provided that includes a waveguide configured to propagate first light; an optical coupler on the waveguide and configured to couple the first light out of the waveguide; a tint layer overlapping the optical coupler and configured to pass second light to the waveguide, the tint layer including a first substrate, a first electrode layered onto the first substrate, a second substrate, a second electrode layered onto the second substrate, and an electrochromic material interposed between the first and second electrodes; a driver configured to generate a voltage across the first and second electrodes; a first conductive wire that couples the driver to the first electrode and that is soldered to the first electrode; and a second conductive wire that couples the driver to the second electrode and that is soldered to the second electrode.

In an example, an electronic device is provided that includes a waveguide configured to propagate first light; an optical coupler on the waveguide and configured to couple the first light out of the waveguide; a tint layer overlapping the optical coupler and configured to pass second light to the waveguide, the tint layer having first and second electrodes and an electrochromic material between the first and second electrodes; and a driver configured to generate a voltage across the first and second electrodes, the driver including a first circuit configured to drive the first electrode based on a reference voltage, and a second circuit configured to drive the second electrode based on the reference voltage.

In another example, the first circuit comprises a buck converter.

In another example, the second circuit comprises a low-dropout (LDO) regulator and an inverter.

In another example, the second circuit comprises an additional buck converter.

In another example, the second circuit further includes a first transistor having a first source/drain terminal coupled to the second electrode and having a first gate terminal; a second transistor having a second source/drain terminal coupled to the first source/drain terminal, having a third source/drain terminal coupled to an output of the additional buck converter, and having a second gate terminal; and a third transistor having a fourth source/drain terminal coupled to an input of the buck converter, the first gate terminal, and the second gate terminal.

In another example, the first circuit comprises a low-dropout (LDO) regulator.

In another example, the second circuit comprises an additional LDO regulator.

In another example, the first circuit comprises a digital-to-analog converter (DAC) and an analog buffer.

In another example, the second circuit comprises an additional DAC and an additional analog buffer.

In an example, an electronic device is provided that includes a waveguide configured to propagate first light; an optical coupler on the waveguide and configured to couple the first light out of the waveguide; a tint layer overlapping the optical coupler and configured to pass second light to the waveguide, the tint layer having first and second electrodes and an electrochromic material between the first and second electrodes; and a driver configured to generate a voltage across the first and second electrodes, wherein the driver comprises a tunable circuit configured to drive both the first electrode and the second electrode.

In another example, the tunable circuit comprises a single inductor multiple output (SIMO) buck converter having a first output coupled to the first electrode and a second output coupled to the second electrode.

In another example, the electronic device further includes a first transistor having a first source/drain terminal coupled to the first electrode and the first output of the SIMO buck converter; and a second transistor having a second source/drain terminal coupled to the second electrode and the second output of the SIMO buck converter.

In another example, the tunable circuit comprises an analog buffer having an output coupled to the tint layer, a first input configured to receive a pulse width modulated (PWM) control signal, and a second input coupled to the output.

In another example, the tunable circuit comprises an H-bridge having a first output coupled to the first electrode and a second output coupled to the second electrode.

In another example, the tunable circuit further includes a digital-to-analog converter and an analog buffer coupled to an input of the H-bridge.

In another example, the tunable circuit further includes a low-dropout (LDO) regulator having an output coupled to an input of the H-bridge.

In another example, the tunable circuit further includes a tunable buck converter having an output coupled to an input of the H-bridge.

In an example, an electronic device is provided that includes a waveguide configured to propagate first light; an optical coupler on the waveguide and configured to couple the first light out of the waveguide; a tint layer overlapping the optical coupler and configured to pass second light to the waveguide, the tint layer having first and second electrodes and an electrochromic material between the first and second electrodes; and a driver configured to generate a voltage across the first and second electrodes, the driver being configured to assert the voltage at a first magnitude at which the tint layer exhibits a first tint level, assert the voltage at a second magnitude at which the tint layer exhibits a second tint level greater than the first tint level, the second magnitude being greater than the first magnitude, and pulse the voltage to a third magnitude greater than the second magnitude during a transition of the tint layer from the first tint level to the second tint level.

In another example, the first magnitude is zero volts.

In another example, the driver is further configured to perform an additional pulse of the voltage during the transition of the tint layer from the first tint level to the second tint level.

In another example, the additional pulse has the third magnitude.

In another example, the additional pulse has a fourth magnitude greater than the second magnitude and less than the third magnitude.

In another example, the additional pulse has a fourth magnitude greater than the third magnitude.

In another example, the additional pulse has a fourth magnitude greater than the first magnitude and less than the second magnitude.

In another example, the pulse of the voltage to the third magnitude has a duration and the additional pulse has the duration.

In another example, the pulse of the voltage to the third magnitude has a first duration and the additional pulse has a second duration different from the first duration.

In another example, the electronic device further includes a switch configured to decouple the first and second electrodes from the driver during or between the pulse and the additional pulse of the voltage.

In another example, the electronic device further includes a switch configured to decouple the first and second electrodes from the driver during the transition of the tint layer from the first tint level to the second tint level.

In another example, the electronic device further includes a switch configured to decouple the first and second electrodes from the driver while the tint layer has the second tint level.

In another example, the driver is further configured to pulse the voltage to a fourth magnitude less than the first magnitude during a transition of the tint layer from the second tint level to the first tint level.

In an example, an electronic device is provided that includes a waveguide configured to propagate first light; an optical coupler on the waveguide and configured to couple the first light out of the waveguide; a tint layer overlapping the optical coupler and configured to pass second light to the waveguide, the tint layer having first and second electrodes and an electrochromic material between the first and second electrodes; and a driver configured to generate a voltage across the first and second electrodes, the driver being configured to assert the voltage at a first magnitude at which the tint layer exhibits a first opacity, assert the voltage at a second magnitude at which the tint layer exhibits a second opacity less than the first opacity, the second magnitude being less than the first magnitude, and pulse the voltage to a third magnitude less than the second magnitude during a transition of the tint layer from the first opacity to the second opacity.

In another example, the second magnitude is zero volts.

In another example, the driver is further configured to perform an additional pulse of the voltage during the transition of the tint layer from the first opacity to the second opacity.

In another example, the additional pulse has the third magnitude.

In another example, the additional pulse has a fourth magnitude greater than the second magnitude.

In another example, the additional pulse has a fourth magnitude greater than the third magnitude and less than the second magnitude.

In another example, the pulse of the voltage to the third magnitude has a duration and the additional pulse has the duration.

In another example, the pulse of the voltage to the third magnitude has a first duration and the additional pulse has a second duration different from the first duration.

In another example, the electronic device further includes a switch configured to decouple the first and second electrodes from the driver during or between the pulse of the voltage and the additional pulse.

In another example, the electronic device further includes a switch configured to decouple the first and second electrodes from the driver during the transition of the tint layer from the first opacity to the second opacity.

In another example, the electronic device further includes a switch configured to decouple the first and second electrodes from the driver while the tint layer has the first opacity.

In an example, an electronic device is provided that includes a waveguide configured to propagate first light; an optical coupler on the waveguide and configured to couple the first light out of the waveguide; a tint layer overlapping the optical coupler and configured to pass second light to the waveguide, the tint layer having first and second electrodes and an electrochromic material between the first and second electrodes; a driver configured to generate a voltage across the first and second electrodes and at which the tint layer exhibits a tint level; control lines that couple the driver to the first and second electrodes; and a switch disposed on the control lines, wherein the switch is configured to periodically float the first and second electrodes with respect to the driver while the tint layer exhibits the tint level.

In an example, an electronic device is provided that includes a waveguide configured to propagate first light; an optical coupler on the waveguide and configured to couple the first light out of the waveguide; a tint layer overlapping the optical coupler and configured to pass second light to the waveguide; a driver configured to drive the tint layer at a first location on the tint layer; and a sensor coupled to a second location on the tint layer, the second location being different from the first location.

In another example, the tint layer includes a first substrate; a first electrode layered onto the first substrate, the driver being coupled to the first electrode at the first location; a second substrate; a second electrode layered onto the second substrate; and an electrochromic material between the first and second electrodes.

In another example, the first location is along a lateral periphery of the tint layer.

In another example, the driver is further configured to drive the tint layer at a third location along the lateral periphery of the tint layer, the third location being different from the first location and the second location.

In another example, the electronic device further includes a conductive contact at the second location, wherein conductive contact is layered onto the first substrate and the sensor is coupled to the conductive contact.

In another example, the conductive contact overlaps the optical coupler and is offset from the lateral periphery of the tint layer.

In another example, the sensor includes a voltage sensor configured to sense a voltage across the tint layer at the second location.

In another example, the electronic device further includes one or more processors configured to detect a steady state of the tint layer based on the voltage across the tint layer at the second location, wherein the tint layer exhibits an optical characteristic at the second location that is different from an optical characteristic of the tint layer at the first location due to a resistance of the first and second electrodes between the first and second locations.

In another example, the electronic device further includes a current sensor configured to sense a current flowing into the first location from the driver.

In an example, an electronic device is provided that includes a waveguide configured to propagate first light; an optical coupler on the waveguide and configured to couple the first light out of the waveguide; a tint layer overlapping the optical coupler and configured to pass second light to the waveguide, the tint layer having first and second electrodes and an electrochromic material between the first and second electrodes; and a driver configured to generate a voltage across the first and second electrodes, the driver including a digital-to-analog converter (DAC), a buck converter, and a low-dropout (LDO) regulator coupled in series with the buck converter between the DAC and the tint layer.

In another example, the driver further includes an H-bridge having an input, a first output coupled to the first electrode of the tint layer, and a second output coupled to the second electrode of the tint layer, the LDO regulator being coupled in series between an output of the buck converter and the input of the H-bridge.

In another example, the electronic device further includes a first buffer coupled between an output of the DAC and the buck converter; and a second buffer coupled between the output of the DAC and the LDO regulator.

In another example, the electronic device further includes a switch having an output terminal coupled to an input of the first buffer; a first feedback path that couples the output of the buck converter to a first input terminal of the switch; and a second feedback path that couples an output of the LDO regulator to a second input terminal of the switch and to an input of the second buffer.

In another example, the switch has a first state in which the first input terminal is coupled to the output terminal, the switch has a second state in which the second input terminal is coupled to the output terminal, the buck converter is configured to drive the tint layer while the switch is in the second state, and the LDO regulator is configured to drive the tint layer while the switch is in the first state.

In another example, the electronic device further includes a switch having a first input terminal coupled to an output of the buck converter, a second input terminal coupled to an output of the LDO regulator, and an output terminal; and a buffer having a first input coupled to the output terminal of the switch, a second input coupled to an output of the DAC, and an output coupled to an input of the buck converter.

In an example, an electronic device is provided that includes a waveguide configured to propagate first light; an optical coupler on the waveguide and configured to couple the first light out of the waveguide; a tint layer overlapping the optical coupler and configured to pass second light to the waveguide, the tint layer having first and second electrodes and an electrochromic material between the first and second electrodes; a current driver configured to drive, at a first time, the tint layer using a drive current; and a voltage driver configured to drive, at a second time different than the first time, the tint layer using a voltage across the first and second electrodes.

In another example, the electronic device further includes switching circuitry that communicably couples the current driver and the voltage driver to the tint layer, wherein the switching circuitry is switchable between at least first and second switch states, the current driver is configured to drive the tint layer while the switching circuitry is in the first switch state, and the voltage driver is configured to drive the tint layer while the switching circuitry is in the second switch state.

In another example, the electronic device further includes a voltage sensor coupled to the first and second electrodes and configured to measure the tint layer at the first time; and a Coulomb counter coupled to the first electrode and configured to measure a charge of the tint layer at the second time.

In another example, the current driver comprises a current digital to analog converter (IDAC) and the voltage driver comprises a tunable buck converter.

In another example, the current driver is configured to generate one or more overdrive pulses in the drive current.

The foregoing is merely illustrative and various modifications can be made to the described embodiments. The foregoing embodiments may be implemented individually or in any combination.

What is claimed is:

1. An electronic device comprising:
a waveguide configured to propagate first light;
an optical coupler on the waveguide and configured to couple the first light out of the waveguide;
a tint layer overlapping the optical coupler and configured to pass second light to the waveguide, the tint layer having first and second electrodes and an electrochromic material between the first and second electrodes; and
a driver configured to generate a voltage across the first and second electrodes, wherein the driver includes
a first circuit configured to drive the first electrode based on a reference voltage, and
a second circuit configured to drive the second electrode based on the reference voltage.

2. The electronic device of claim 1, wherein the first circuit comprises a buck converter.

3. The electronic device of claim 2, wherein the second circuit comprises a low-dropout (LDO) regulator and an inverter.

4. The electronic device of claim 2, wherein the second circuit comprises an additional buck converter.

5. The electronic device of claim 4, wherein the second circuit further comprises:
a first transistor having a first source/drain terminal coupled to the second electrode and having a first gate terminal;
a second transistor having a second source/drain terminal coupled to the first source/drain terminal, having a third source/drain terminal coupled to an output of the additional buck converter, and having a second gate terminal; and
a third transistor having a fourth source/drain terminal coupled to an input of the buck converter, the first gate terminal, and the second gate terminal.

6. The electronic device of claim 1, wherein the first circuit comprises a low-dropout (LDO) regulator, wherein the second circuit comprises an additional LDO regulator, wherein the first circuit comprises a digital-to-analog converter (DAC) and an analog buffer, and wherein the second circuit comprises an additional DAC and an additional analog buffer.

7. The electronic device of claim 1, wherein:
the driver is configured to overdrive, underdrive, and float the voltage, and
the driver is coupled to the first electrode over a first tail of a flexible printed circuit that is mounted to a first substrate of the tint layer and is coupled to the second electrode over a second tail of the flexible printed circuit that is mounted to a second substrate of the tint layer.

8. An electronic device comprising:
a waveguide configured to propagate first light;
an optical coupler on the waveguide and configured to couple the first light out of the waveguide;
a tint layer overlapping the optical coupler and configured to pass second light to the waveguide, the tint layer having first and second electrodes and an electrochromic material between the first and second electrodes; and
a driver configured to generate a voltage across the first and second electrodes, wherein the driver comprises a tunable circuit configured to drive both the first electrode and the second electrode.

9. The electronic device of claim 8, wherein the tunable circuit comprises a single inductor multiple output (SIMO) buck converter having a first output coupled to the first electrode and a second output coupled to the second electrode.

10. The electronic device of claim 9, further comprising:
a first transistor having a first source/drain terminal coupled to the first electrode and the first output of the SIMO buck converter; and
a second transistor having a second source/drain terminal coupled to the second electrode and the second output of the SIMO buck converter.

11. The electronic device of claim 8, wherein the tunable circuit comprises an analog buffer having an output coupled to the tint layer, a first input configured to receive a pulse width modulated (PWM) control signal, and a second input coupled to the output.

12. The electronic device of claim 8, wherein the tunable circuit comprises an H-bridge having a first output coupled to the first electrode and a second output coupled to the second electrode.

13. The electronic device of claim 12, wherein the tunable circuit further comprises:
a digital-to-analog converter and an analog buffer coupled to an input of the H-bridge.

14. The electronic device of claim 12, wherein the tunable circuit further comprises:
a low-dropout (LDO) regulator having an output coupled to an input of the H-bridge.

15. The electronic device of claim 12, wherein the tunable circuit further comprises:
a tunable buck converter having an output coupled to an input of the H-bridge.

16. An electronic device comprising:
a waveguide configured to propagate first light;
an optical coupler on the waveguide and configured to couple the first light out of the waveguide;
a tint layer overlapping the optical coupler and configured to pass second light to the waveguide, the tint layer having first and second electrodes and an electrochromic material between the first and second electrodes;
a current driver configured to drive, at a first time, the tint layer using a drive current; and
a voltage driver configured to drive, at a second time different than the first time, the tint layer using a voltage across the first and second electrodes.

17. The electronic device of claim 16, further comprising:
switching circuitry that communicably couples the current driver and the voltage driver to the tint layer, wherein the switching circuitry is switchable between at least first and second switch states, the current driver is configured to drive the tint layer while the switching circuitry is in the first switch state, and the voltage driver is configured to drive the tint layer while the switching circuitry is in the second switch state.

18. The electronic device of claim 16, further comprising:
a voltage sensor coupled to the first and second electrodes and configured to measure the tint layer at the first time; and
a Coulomb counter coupled to the first electrode and configured to measure a charge of the tint layer at the second time.

19. The electronic device of claim 16, wherein the current driver comprises a current digital to analog converter (IDAC) and the voltage driver comprises a tunable buck converter.

20. The electronic device of claim 16, wherein the current driver is configured to generate one or more overdrive pulses in the drive current.
